(19) United States
(12) Patent Application Publication
(10) Pub. No.: US 2025/0074001 A1
(43) Pub. Date: Mar. 6, 2025

(54) VOLUMETRIC THREE-DIMENSIONAL (3D) PRINTING SYSTEM

(71) Applicant: QUADRATIC 3D, INC., CHARLESTOWN, MA (US)

(72) Inventors: GREGG ETHAN FAVALORA, BEDFORD, MA (US); RYAN G. SARGENT, MANCHESTER, NH (US); ERIC W. PETERSON, NORTH READING, MA (US); RICHARD NELSON ROSE, CAMBRIDGE, MA (US); KAREN TWIETMEYER, BELMONT, MA (US); SAMUEL N. SANDERS, ARLINGTON, MA (US); EMILY M. ARNDT, AKRON, OH (US)

(21) Appl. No.: 18/951,371

(22) Filed: Nov. 18, 2024

Related U.S. Application Data
(63) Continuation of application No. PCT/US2023/022907, filed on May 19, 2023.
(60) Provisional application No. 63/343,562, filed on May 19, 2022.
(60) Provisional application No. 63/400,448, filed on Aug. 24, 2022.

(51) Int. Cl. B29C 64/379; B29C 64/182; B29C 64/264; B29C 64/35; B33Y 30/00; B33Y 40/20

(52) U.S. Cl. CPC B29C 64/379; B29C 64/182; B29C 64/264; B29C 64/35; B33Y 30/00; B33Y 40/20

(57) ABSTRACT

A method may include (a) providing a cartridge including a volume of photohardenable composition in an irradiation zone; (b) selectively irradiating the volume of the photohardenable composition included in the cartridge with one or more wavelengths of excitation light to at least partially harden, polymerize, and/or cross-link the resin composition to at least partially form one or more objects in the volume; (c) removing the cartridge from the irradiation zone after selective irradiation step; and optionally repeating steps (a)-(c) with a series of one or more additional cartridges including a next volume of photohardenable composition. An assembly for printing 3D objects may include a printer having at least one excitation light source configured to solidify photohardenable resin and form one or more 3D objects in a cartridge.

### CROSS-REFERENCE TO RELATED APPLICATIONS

This application is a continuation of International Application No. PCT/US2023/022907, filed 19 May 2023, which International Application claims priority to U.S. Provisional Patent Application No. 63/343,562 of Quadratic 3D, Inc. filed May 19, 2022 for “Cartridge, System, and Method for Volumetric 3D Printing” and U.S. Provisional Patent Application No. 63/400,448 of Quadratic 3D, Inc. filed Aug. 24, 2022 for “Volumetric Three-Dimensional (3D) Printing System”, each of the foregoing being hereby incorporated herein by reference in its entirety for all purposes.

### FIELD

Aspects of this invention relate generally to three-dimensional (3D) printing and, in particular, to a method and apparatus for hands-free volumetric printing of one or more 3D objects.

### BACKGROUND

3D printers are known for use in forming a variety of objects. Certain 3D printers may direct one or more light sources into a container of photohardenable material to form a 3D object within the container. Such 3D printers may form 3D objects on a build platform positioned within the container. Once the 3D object is printed, it must be separated from the build platform.

It would be desirable to provide a zero touch, or hands-free, system for printing one or more 3D objects by projecting one or more lights sources into a container of photohardenable material, and performing post-processing steps on the 3D object(s) including washing, drying, curing, inspection, and/or packaging.

### SUMMARY

The present invention includes a high throughput system and method for the manufacture of multiple 3D objects. The principles of the invention may be used to create 3D objects within a volume of resin in a cartridge by exposing the resin to one or more excitation light sources.

In accordance with a first aspect, a method may include (a) providing a cartridge including a volume of photohardenable composition in an irradiation zone; (b) selectively irradiating the volume of the photohardenable composition included in the cartridge with one or more wavelengths of excitation light to at least partially harden, polymerize, and/or cross-link the resin composition to at least partially form one or more objects in the volume; (c) removing the cartridge from the irradiation zone after selective irradiation step; and optionally repeating steps (a)-(c) with a series of one or more additional cartridges including a next volume of photohardenable composition.

In accordance with another aspect, a 3D printing assembly includes a printer gripping assembly configured to move a cartridge containing a photohardenable resin. A printer assembly includes at least one excitation light source configured to solidify the photohardenable resin and form one or more 3D objects in the cartridge. A cartridge flipping assembly is configured to insert a basket in an inverted position into the cartridge and rotate the cartridge to an inverted position such that the one or more 3D objects are transferred into the basket and the liquid resin flows out of the cartridge. A basket gripping assembly is configured to remove the basket from the cartridge and transfer the basket to a first washing station. A second washing station is positioned downstream of the first washing station. A drying station is positioned downstream of the second washing station. A pre-curing station is positioned downstream of the drying station. A transfer assembly is configured to transfer the one or more 3D objects from the basket into a curing tray. An inspection station is configured to inspect the one or more 3D objects in the curing tray. A sealing station is configured to secure a sealing film to a top surface of the curing tray. A transfer tray is configured to receive one or more curing trays.

The use of an automated system to print 3D objects within resin provided in cartridges can provide significant improvements in throughput and efficiency, while reducing costs for the manufacture of multiple 3D objects. These and additional features and advantages disclosed here will be further understood from the following detailed disclosure of certain embodiments.

### BRIEF DESCRIPTION OF THE DRAWINGS

FIG. 1 is schematic view of a process of printing one or more 3D objects.

FIG. 2 is a perspective view of a printing assembly for use in the process of FIG. 1.

FIG. 3 is a perspective view of a portion of the printing assembly of FIG. 2, showing an array of cartridges ready to be printed.

FIG. 4 is a perspective view of a portion of the printing assembly of FIG. 2, showing a cartridge being loaded into a printer.

FIG. 5 is a perspective view of a portion of the printing assembly of FIG. 2, showing printing of a first volume of a cartridge.

FIG. 6 is a perspective view of a portion of the printing assembly of FIG. 2, showing further printing of a first volume of the cartridge.

FIG. 7 is a perspective view of a portion of the printing assembly of FIG. 2, showing printing of a fourth volume of the cartridge.

FIG. 8 is a perspective view of a portion of the printing assembly of FIG. 2, showing a cartridge with printed 3D objects therein prior to transfer to a basket.

FIG. 9 is a perspective view of a portion of the printing assembly of FIG. 2, showing a cover being removed from the cartridge.

FIG. 10 is a perspective view of a portion of the printing assembly of FIG. 2, showing the basket prior to being inserted into the cartridge.

FIG. 11 is a perspective view of a portion of the printing assembly of FIG. 2, showing the basket inverted and being inserted into the cartridge.

FIG. 12 is a perspective view of a portion of the printing assembly of FIG. 2, showing the basket and cartridge prior to draining resin from the cartridge.

FIG. 13 is a perspective view of a portion of the printing assembly of FIG. 2, showing the cartridge and basket inverted such that resin drains from the cartridge.

FIG. 14 is a perspective view of a portion of the printing assembly of FIG. 2, showing the basket being placed into a basket carriage.

FIG. 15 is a perspective view of a portion of the printing assembly of FIG. 2, showing the basket in the basket carriage and the empty cartridge being lifted from the basket.

FIG. 16 is a perspective view of a portion of the printing assembly of FIG. 2, showing the empty cartridge being taken out of the process flow.

FIG. 17 is a perspective view of a portion of the printing assembly of FIG. 2, showing the empty cartridge being placed in a cartridge collection tray.

FIG. 18 is a perspective view of a portion of the printing assembly of FIG. 2, showing a basket gripping assembly moving the basket.

FIG. 19 is a perspective view of a portion of the printing assembly of FIG. 2, showing the basket being deposited into a first washing basin.

FIG. 20 is a perspective view of a portion of the printing assembly of FIG. 2, showing the basket being deposited into a second washing basin.

FIG. 20A is a perspective view of a portion of the printing assembly of FIG. 2, showing the basket being deposited into a drying basin.

FIG. 21 is a perspective view of a portion of the printing assembly of FIG. 2, showing the basket being deposited into a pre-curing basin.

FIG. 22 is a perspective view of a portion of the printing assembly of FIG. 2, showing a transfer assembly holding a curing tray and a basket.

FIG. 23 is a perspective view of a portion of the printing assembly of FIG. 2, showing a basket being rotated to slide 3D objects into the curing tray.

FIG. 24 is a perspective view of a portion of the printing assembly of FIG. 2, showing separator walls of the transfer assembly that guide 3D objects from the basket into the curing tray.

FIG. 25 is a perspective view of a portion of the printing assembly of FIG. 2, showing an inspection station including a camera used to inspect the 3D objects.

FIG. 26 is a perspective view of a portion of the printing assembly of FIG. 2, showing a sealing station applying a sealing film to the curing tray.

FIG. 27 is a perspective view of a portion of the printing assembly of FIG. 2, showing needles injecting gas into the curing tray as the curing tray is sealed.

FIG. 28 is a perspective view of a portion of the printing assembly of FIG. 2, showing curing trays being transported in transfer trays.

FIG. 29 is a side perspective view of the cartridge of the printing assembly of FIG. 2.

FIG. 30 is a bottom perspective view of the cartridge of FIG. 29.

FIG. 31 is an elevation view of the cartridge of FIG. 29, shown in its position when filled.

FIG. 32 is a bottom perspective view, shown partially cut away, of a portion of the cartridge as shown in FIG. 31.

FIG. 33 is a top perspective view, shown partially cut away, of a portion of the cartridge as shown in FIG. 31.

FIG. 34 depicts an example of dimensional parameters useful for determining a preferred cartridge size. Coordinate axes for the drawing are also shown.

FIG. 35 depicts an example of an example of dimensional parameters useful for determining a preferred cartridge size. Coordinate axes for the drawing are also shown.

FIG. 36 depicts a legend for FIGS. 34 and 35.

FIG. 37 depicts an example of dimensional parameters useful for determining a preferred cartridge size. Coordinate axes for the drawing are also shown.

FIG. 38 depicts an example of a dimensional parameters for a cartridge including multiple printing zones, one of which is outlined and labeled as “1 Bounding Box”. Coordinate axes for the drawing are also shown.

FIG. 39 depicts a legend for FIGS. 2A and 2B.

FIG. 40 depicts an example of a cartridge including five printing zones.

FIG. 41 depicts an example of the system including two optical systems positioned to direct excitation light projections into a printing zone. (Other optical systems associated with the other printing zones are not shown.)

The figures referred to above are not drawn necessarily to scale, should be understood to provide a representation of particular embodiments disclosed herein, and are merely conceptual in nature and illustrative of the principles involved. Some features of the 3D printing assembly depicted in the drawings have been enlarged or distorted relative to others to facilitate explanation and understanding. The same reference numbers are used in the drawings for similar or identical components and features shown in various alternative embodiments. 3D printing assemblies as disclosed herein would have configurations and components determined, in part, by the intended application and environment in which they are used.

### DETAILED DESCRIPTION OF CERTAIN PREFERRED EMBODIMENTS

The present invention may be embodied in various forms. For convenience, the terms “upper” and “lower” and “top” and “bottom” are used herein to differentiate between the upper and lower ends of the components described herein. The terms “inner” and “outer” are used herein to differentiate between the inner and outer portions of the components described herein. It is to be appreciated that “upper” and “lower”, and “top” and “bottom”, and “inner” and “outer” are used only for ease of description and understanding and that they are not intended to limit the possible spatial orientations of the components described herein during assembly or use.

The term “substantially”, as used herein, is meant to mean mostly, or almost the same as, within the constraints of sensible commercial engineering objectives, costs, manufacturing tolerances, and capabilities in the field of volumetric 3D printing assembly manufacturing and use. Similarly, the term “approximately” as used herein is meant to mean close to, or about a particular value, within the constraints of sensible commercial engineering objectives, costs, manufacturing tolerances, and capabilities in the field of volumetric 3D printing assembly manufacturing and use.

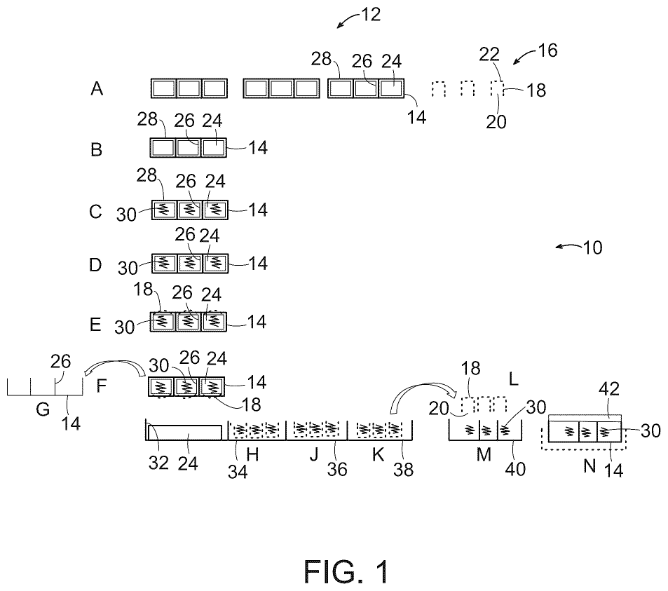

A method 10 for printing one or more 3D objects is schematically presented in FIG. 1. In step A, a first array 12 of primary containers, such as cartridges 14, and a second array 16 of secondary containers, such as baskets 18 may be provided. Each basket 18 may have an open end 20 and an opposed closed end 22.

Each basket 18 may be configured such that liquid, such as resin, can flow through it, while still maintaining the ability to retain a solid object therein. In certain embodiments, baskets 18 may be formed of perforated material. In other embodiments, baskets 18 may be formed of a grated or mesh material. Other suitable forms for baskets 18 will become readily apparent to those skilled in the art, given the benefit of this disclosure.

Each cartridge 12 may contain a volume of a photopolymerizable or photohardenable composition 24. Photohardenable composition may be a resin 24. Resin 24 may include liquids such as monomers and oligomers, additives, as well as a photoinitiator, and may undergo at least partial hardening, polymerization, or cross-linking when exposed to one or more excitation light sources to at least partially form an object. Resin 24 may also include polymers, pre-polymers, additives, and fillers. Other suitable elements to be added to resin 24 will become readily apparent to those skilled in the art, given the benefit of this disclosure.

Preferred photoinitiators include photoswitchable photoinitiators that are activatable by exposure to light having a first wavelength and light having a second wavelength to at least partially harden, polymerize, or cross-link the photohardenable composition, wherein the first and second wavelengths are different. A photohardenable composition that displays non-Newtonian rheological behavior can be preferred. Examples of such non-Newtonian rheological behavior include but are not limited to pseudoplastic fluid, yield pseudoplastic, Bingham pseudoplastic, or Bingham plastic behavior. Photohardenable compositions that display pseudoplastic or Bingham pseudoplastic behavior can be more preferred. Photohardenable compositions that demonstrate non-Newtonian behavior can facilitate forming an object in a volume of photohardenable composition, without requiring the addition of support structures, upon selective exposure to excitation light of one or more wavelengths wherein the object remains at a fixed position or is minimally displaced in the volume of the unhardened photohardenable composition during formation of the object. Minimal displacement refers to displacement of the object being formed during its formation in the volume that is acceptable for precisely producing the intended part (or object) geometry. Support structures are typically required by most 3D printing technologies to stabilize the part during printing or to allow printing of thin or fragile overhanging portions of the part; after printing, post-processing is required to remove the support structures, which can damage or leave marks on the printed part. Avoiding addition of support structures can advantageously simplify post-processing of printed parts and improve part surface quality. Non-Newtonian behavior of photohardenable compositions can additionally simplify separation of the part from unpolymerized photohardenable composition upon application of stress. Exemplary photoswitchable photoinitiators and photohardenable compositions including same that may be included in the methods and printing assembly described herein are discussed in International Application No. PCT/US2022/037491 of Quadratic 3D, Inc. filed Jul. 18, 2022 for “Photohardenable Compositions And Methods For Forming An Object In A Volume Of A Photohardenable Composition” and U.S. Provisional Patent Application No. 63/341,594 of Quadratic 3D, Inc. filed May 13, 2022 for “Photoinitiators, Compositions, and Methods For Forming An Object”, each of which is incorporated herein by reference.

At step B, one cartridge 14 full of resin 24 may be removed from first array 12 and introduced into a printer containing an irradiation zone. It is to be appreciated that each cartridge 14 may include one or more print regions 26 in which 3D objects may be created. In the embodiment illustrated in FIG. 1, each cartridge 14 has three (3) print regions 26 such that three separate 3D objects may be sequentially formed within the volume of resin 24 in cartridge 14. For illustration purposes, vertical lines are shown here within cartridge 14 to delineate the separate print regions 26. However, it is to be appreciated that there may be no actual physical barrier within cartridge 14 between the individual print regions 26.

It is to be appreciated that each cartridge 14 may include one or any other number of print regions 26. In further embodiments described herein, each cartridge 14 may include five (5) print regions 26. Other embodiments naturally may include more than five (5) print regions 26. A suitable number of print regions 26 for cartridge 14 will become readily apparent to those skilled in the art, given the benefit of this disclosure.

Cartridges 14 can be open containers or closed containers. An open container is not airtight and can optionally include one or more openings while retaining its ability to contain a volume of resin 24. For example, cartridge 14 can have one or more openings above the volume-containing portion of the cartridge, e.g., a complete or partially open top side of the container and/or one or more openings in a side wall or end of the container. The container can be a closable container. Examples of closable containers include, for example, but are not limited to, a container with a removable cover or a hinged cover. A removable or hinged cover can be a full or partial removable cover or a full or partial hinged cover. In the embodiment illustrated in FIG. 1, cartridge 14 may include a removable cover 28.

At step C, the volume of resin 24 in each cartridge 14 may be irradiated with one or more one or more wavelengths of excitation light to at least partially harden, polymerize, and/or cross-link resin 24 to at least partially form the one or more 3D objects 30 in the volume of resin 24.

In certain embodiments, for example, that include irradiation with two light sources, a primary light source may be a projector that patterns an image in one wavelength of light, and a secondary light source may project a light sheet, which may be a one-dimensional line or a scanned beam, in a different wavelength than that of the patterned image. The patterned image and light sheet may be arranged such that they are projected to meet at a distinct intersection surface in space, and in certain embodiments may be projected orthogonally with respect to one another.

Examples of projector or projection devices for use in the methods and systems described herein may include, but are not limited to, a laser projection system, a liquid crystal display (also referred to herein as “LCD”), a spatial light modulator (also referred to herein as “SLM”) (for example, but not limited to, a digital micromirror device (also referred to herein as “DMD”) or a digital light processing device (also referred to herein as “DLP”)), a micro-LED array, a vertical cavity laser array (also referred to herein as “VCL”), a Vertical Cavity Surface Emitting Laser array (also referred to herein as “VCSEL”), a liquid crystal on silicon (also referred to herein as “LCOS”) projector, and a scanning laser system. (Light emitting diode is also referred to herein as “LED”.)

Examples of light sources of the excitation light that may be suitable for use in various aspects of the present invention including light sources include, by way of example and non-limitation, lasers, laser diodes, light emitting diodes, light-emitting diodes (LEDs), micro-LED arrays, vertical cavity lasers (VCLs), and filtered lamps. Such light sources are commercially available and selection of a suitable light source can be readily made by one of ordinary skill in the relevant art. LEDs of the type such as Phlatlight LEDs available from Luminus for use with DMDs can be preferred.

Optionally, the excitation light can be temporally and/or spatially modulated. Optionally, the intensity of the excitation light can be modulated. Optionally, source drive modulation can be used to adjust the absolute power of the light beam.

A configuration of a projector device and light source can optionally further include one or more optical components (e.g., projection optics, illumination optics, lenses, lens systems, mirrors, prisms, etc.)

In embodiments in which excitation light is projected from two light sources into cartridge 14, resin 14 is at least partially hardened, polymerized, or cross-linked at the intersection region of the projections of excitation light from two light sources. By moving the intersection through cartridge 14, a 3D object may be created from resin 14.

In certain embodiments, the intersection of the primary and secondary sources of excitation light may be moved with respect to cartridge 14. In other embodiments, the intersection may be fixed, and cartridge 14 may be moved in order to form one or more 3D objects 30 in cartridge 14.

At step D, cartridge 14 may be removed from the printer, and cover 28 may be removed from cartridge 14. Cover 28 may then be collected for cleaning, and then installed on another cartridge 14 after it has been filled with resin 24.

At step E, a basket 18 may be inserted into cartridge 14 in inverted fashion such that the open end 20 of basket 18 is placed over a corresponding 3D object 30 within cartridge 14, and closed end 22 faces upwardly.

At step F, cartridge 14 may be inverted such that resin 24 flows out of cartridge 14 into a collection basin 32. Resin 24 may be subsequently retrieved from collection basin 32 for reuse in forming additional 3D objects 30.

At step G, cartridge 14, which is an in inverted position, is rotated to an upright position. Cartridge 14 may then be transferred to a refill station where additional resin 24 can be inserted into cartridge 14. Optionally, cartridge 14 can be cleaned prior to refilling. Cartridge 14 with resin 24 can then subsequently be positioned within first array 12 for use in forming additional 3D objects 30. It is to be appreciated that cartridge 14 may be disposed at this step in the event that cartridge 14 is not suitable for reuse.

At step H, basket 18 with 3D objects 30 seated therein may be moved to a first washing station 34, where 3D objects 30 may undergo a first washing with a cleaning solution. At step J, basket 18 with 3D objects 30 seated therein may be moved from first washing station 34 to a second washing station 36, where 3D objects 30 may undergo a second washing with a cleaning solution.

At step K, basket 18 with 3D objects 30 seated therein may be moved from second washing station 36 to a drying station 38, where 3D objects 30 within basket 18 may be dried. In certain embodiments, 3D objects within basket may also undergo an initial ultraviolet (UV) cure at drying station 38 or at a separate curing station downstream of drying station 38.

At step L, basket 18 may be transferred from drying station 38 and inverted such that closed end 22 faces upwardly and open end 20 of basket 18 faces downwardly, causing 3D objects 30 to fall or slide out of basket 18 into a curing tray 40.

At step M, with 3D objects 30 seated in curing tray 40, additional processing steps may be formed including polishing of 3D objects 30, for example. Additionally, during step M, oxygen may be purged from curing tray 40, an inert gas such as argon or nitrogen may be introduced into curing tray 40 to provide an inert atmosphere for 3D objects 30. A cover or seal 42 may then be secured to curing tray 40.

At step N, 3D objects 30 may be optically inspected, and then subject to additional post-cure treatments including, but not limited to, UV exposure and heating. Curing tray 40 may be seated in a transport tray 44. Transport tray 44 may then be moved to a packaging station (not shown), where curing tray 40 can be labeled and packaged for shipment.

It is to be appreciated that each of steps A-N may be performed by a robotic automated handling assembly in a zero touch, hands-free manner, thereby providing a high throughput system with increased efficiency and reduced costs for the manufacture of multiple 3D objects.

By forming one or more 3D objects 30 within the volume of resin 24 in cartridge 14 without a build platform, there is no expense or labor required to separate the 3D objects from a build platform and, therefore, no chance of damaging 3D objects 30 when removing them from a build platform.

Because each 3D object 30 is formed within a distinct print region 26 of cartridge 14, and then transferred to an individual basket 18, it is easy for the system to track each individual 3D object as it progresses through the automated assembly, thereby enhancing quality control throughout the entire process.

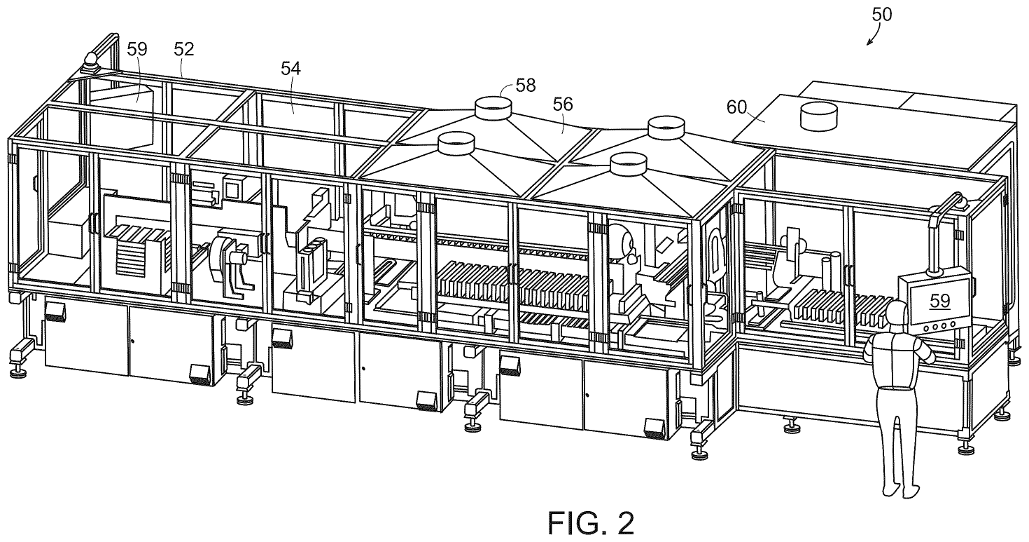

An exemplary volumetric 3D printing assembly 50 is illustrated in FIG. 2. It is to be appreciated that some of the reference numbers used in FIG. 1 to describe the overall printing process may be used in the following drawings for similar or identical components and features shown in various alternative embodiments.

Printing assembly 50 may be configured to be an automated assembly that operates in a zero touch, hands-free manner, thereby providing a high throughput system with increased efficiency and reduced costs for the manufacture of multiple 3D objects. Printing assembly 50 may include an enclosure or housing 52 to house printing assembly 50. Housing 52 may include UV blocking windows 54 to shield elements of the printing process from UV light and for laser safety, e.g., by attenuating the optical power of light that may exit the system. Housing 52 may include one or more ventilation or exhaust hoods 56 with exhaust ports 58 that work in conjunction with one or more exhaust fans (not shown) to allow gases and vapors from the printing process to be evacuated from housing 52.

Printing assembly 50 may include one or more human-machine-interfaces (HMI) 59 that allow an operator to interface with a controller (not shown) for printing assembly 50. The controller can be any type of computer, such as a programmable logic computer (PLC), for example, that allows an operator to control the various components and processes associated with printing assembly 50.

Printing assembly 50 may include a 3D printer assembly 60 that uses excitation light sources to form 3D objects from a volume of resin, as described in greater detail below. It is to be appreciated that various assembly steps or processes, such as the printing of 3D objects, are performed with printing assembly 50 at various locations or stations within printing assembly 50. The steps discussed above with respect to FIG. 1 will be discussed in greater detail below.

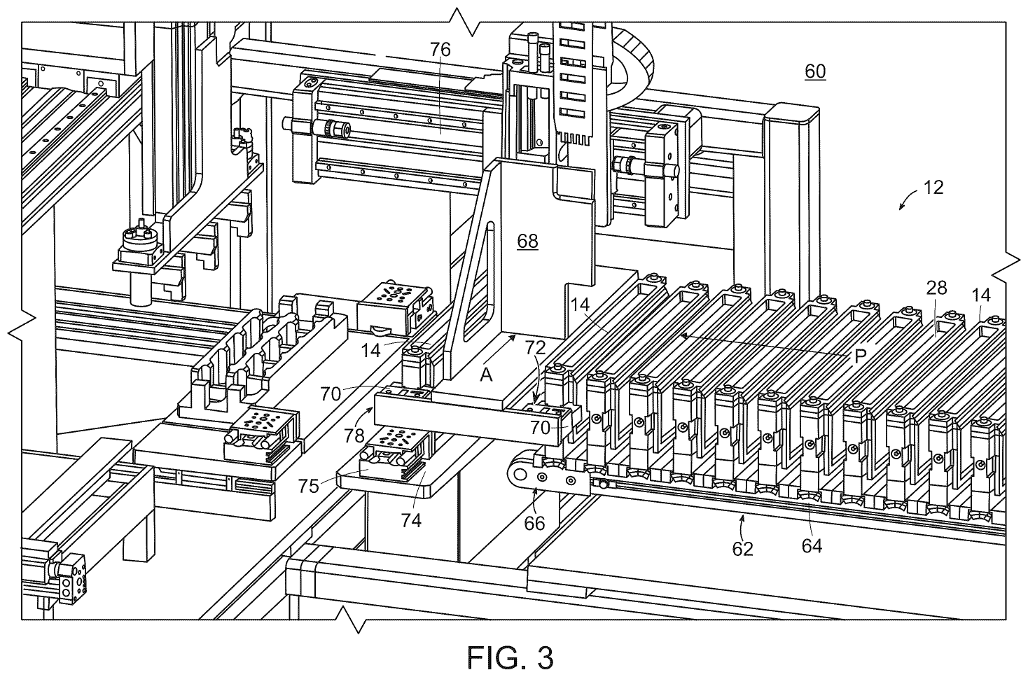

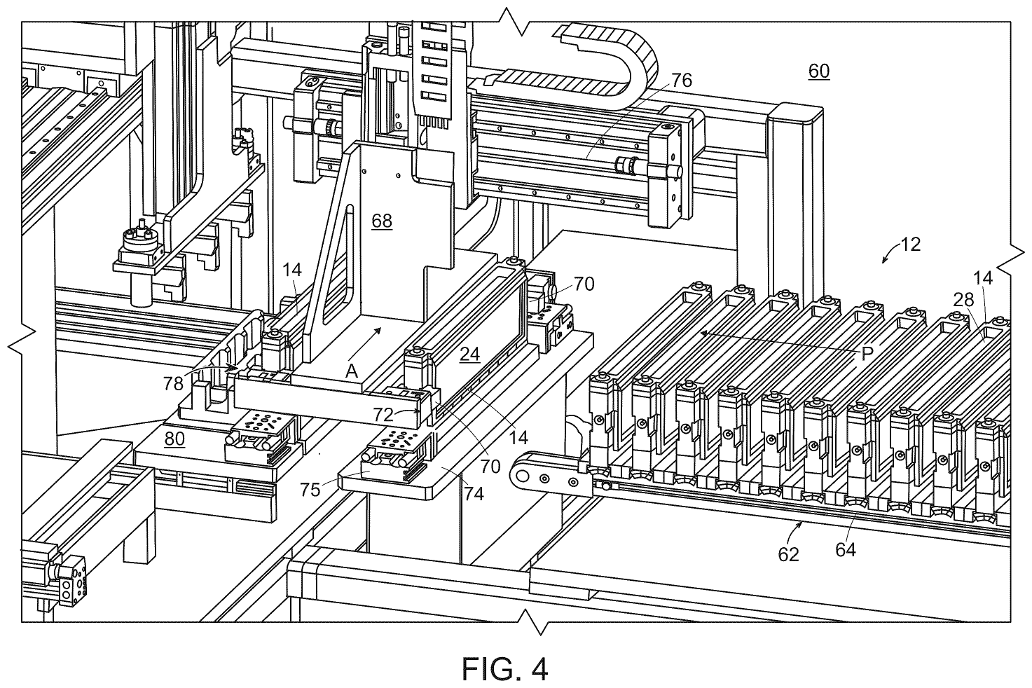

As seen in FIGS. 3-4, first array 12 of cartridges 14 may be positioned on a conveyor assembly 62 that may include one or more conveyor belts 64 that move cartridges 14 forward, or downstream through the printing process in the direction of arrow P to a pick position 66 at a downstream end of conveyor assembly 62. At this point, cartridges 14 are full of resin 24 and have covers 28 secured thereto, and are ready to be moved to printer assembly 60 for printing of 3D objects. It is desirable for resin 24 in the closed cartridge 14 to be bubble-free. It is also desirable, if a cover is included, for there to be no gap between top surface of resin 24 and the inner surface of cover 28, e.g., for resin 24 to be in contact with the inner surface of cover 28.

Cartridge 14 may be constructed from a material comprising, for example, but not limited to, glass, quartz, fluoropolymers (e.g., Teflon FEP, Teflon AF, Teflon PFA), cyclic olefin copolymers, polymethyl methacrylate (PMMA), polynorbornene, sapphire, or transparent ceramic. Other materials with appropriate hardness that are optically transparent and optically flat may also be suitable. Other suitable materials for cartridge 14 will become readily apparent to those skilled in the art, given the benefit of this disclosure.

Each cartridge 14 may include one or more transparent regions to allow the one or more wavelengths of excitation light to enter cartridge 14. For example, one or more of the sidewalls and cover 28 of cartridge 14 may be transparent to allow light to pass therethrough. Additionally, one or more of the walls or sides of cartridge 14, or the entire cartridge 14, can be coated. For example, without limitation, one or more sides can include an anti-reflection coating, a mechanically reinforcing coating, a chemical resistance coating, etc. Optionally, one or more sides can include a coating on its internal surface for enhancing the cleanability thereof of cartridge 14 after it is emptied.

It is to be appreciated that cartridge 14 may be sized to accommodate the size of 3D objects to be printed therein as described in greater detail below.

When a cartridge 14 is positioned at pick position 66, a printer gripping assembly 68 may move a fresh, ready-for-printing cartridge 14 into printer assembly 60. Printer gripping assembly 68 may include one or more cartridge grippers 70 that grasp cartridge 14 to move it into printer assembly 60. As used herein, a gripper may be a claw, a clamp, a pincer, or any other mechanical grasping device suitable for grasping onto, or clamping on to an object so that the object may be moved or otherwise manipulated.

In the illustrated embodiment, a first set 72 of two cartridge grippers 70 operate to grasp opposed sides of cartridge 14. Printer gripping assembly 68 may then move cartridge 14 onto a print carriage 74, as seen in FIG. 4, where cartridge anchoring assemblies 75 may engage cartridge 14 and temporarily secure it to print carriage 74. Printer gripping assembly 68 may include a track or rail 76 along which the components of printer gripping assembly 68, including grippers 70, may move upstream and downstream along the printing process.

Once cartridge 14 has been positioned on print carriage 74, first set 72 of grippers 70 may release cartridge 14 and move upwardly away from cartridge 14 (not shown). Print carriage 74 may then operate to move cartridge 14 laterally out of the printing process in the direction of arrow A into printer assembly 60, where 3D objects are partially or fully formed in cartridge 14, as described in greater detail below.

While first set 72 of cartridge grippers 70 are grasping the ready-for-printing cartridge 14, a second set 78 of cartridge grippers 70 may simultaneously grasp a just-printed cartridge 14 that is seated on print carriage 74 and has just been laterally transferred out of printer assembly 60, as seen in FIG. 3. As seen in FIG. 4, first and second sets 72, 78 of grippers 70 may then travel downstream along track 76, moving the just-printed cartridge 14 to a basket platform 80 that has moved upstream to the off-load position for the just-printed cartridge 14. At this point second set of grippers 70 may release the just-printed cartridge 14 and are moved upwardly away from cartridge 14. The just-printed cartridge 14 may be secured to basket platform 80 with suitable releasable fasteners (not shown).

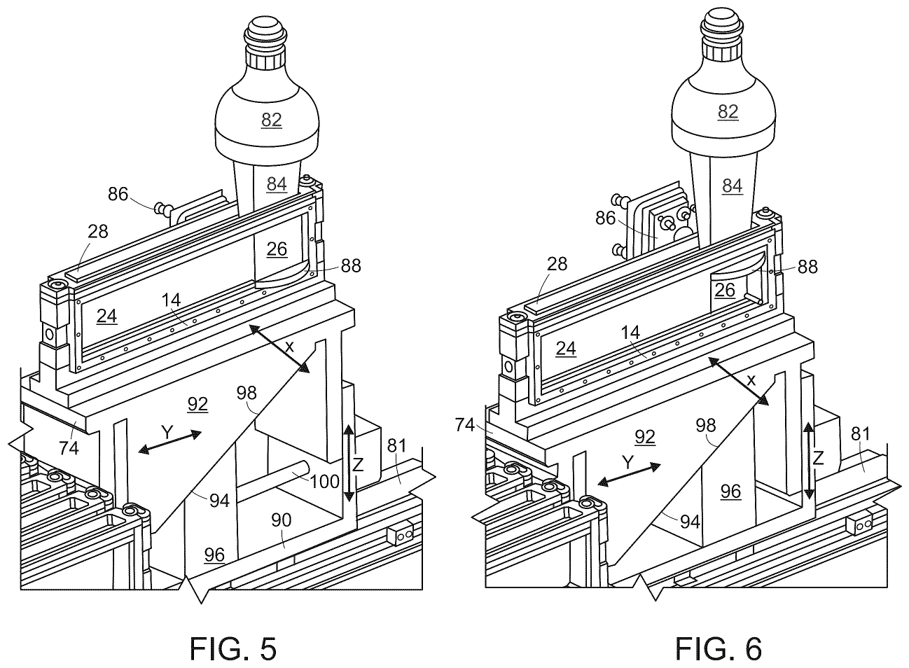

The printing of 3D objects 30 within cartridge 14 will now be illustrated with FIGS. 5-7. Once first set 72 of grippers 70 have moved upwardly away from cartridge 14, print carriage 74 may move along a print carriage track 81 into a printing position within printer assembly 60. As seen in FIG. 5, cartridge 14 is positioned for printing in a first, or innermost print region 26 of cartridge 14.

As noted above, resin 24 in cartridge 14 may be irradiated with one or more one or more wavelengths of excitation light to at least partially harden, polymerize, and/or cross-link resin 24 to at least partially form the one or more 3D objects 30 (not shown) in the volume of resin 24.

In the illustrated embodiment, a primary light source 82 may illuminate a projector device (not shown) that patterns an image 84 in a first wavelength of light by forming a time-series of cross-sectional patterns that correspond to cross-sections of the object to be printed. The image is preferably orthogonal to its projection axis into the cartridge. A secondary light source 86 may illuminate a light sheet generator (not shown) for generating and directing a light sheet 88 in a second wavelength that is a different wavelength than the first wavelength of the patterned image 84. Examples of light sheet generators include, by way of example, a cylindrical lens, a Powell lens, a galvanometer, a polygon scanning mirror, a MEMS scanner, a diffractive optical element, and an axicon lens. The light sheet is preferably directed into the cartridge along a direction orthogonal to the projection axis of the image.

Light sheet 88 is depicted here with a considerable vertical thickness, solely for illustrative purposes. In the illustrated embodiment, patterned image 84 and light sheet 88 are arranged such that they are projected to intersect at a distinct region within cartridge 14.

When image 84 and light sheet 88 are projected into cartridge 14, resin 14 is at least partially hardened, polymerized, or cross-linked at the intersection region of the image and light sheet projections from two light sources. By moving the intersection region through cartridge 14, 3D object 30 may be created from resin 14. In the embodiment illustrated in FIGS. 5-7, the intersection of wave image 84 and light sheet 88 is fixed in space, and cartridge 14 is moved in order to form one or more 3D objects 30 in cartridge 14.

Print carriage 74 may include a housing 90 and a movable first portion 92 that is configured to move vertically with respect to housing 90. First portion 92 may include an angled lower surface 94. A movable second portion 96 of housing 90 may be configured to move horizontally with respect to housing 90, and may include an angled upper surface 98. A piston 100 may be secured at one end thereof to second portion 96 and at its opposed second end to a reciprocating drive assembly (not shown) that operates to move piston back and forth along print carriage track 81.

As piston 100 moves back and forth along print carriage track 81, upper surface 98 of second portion 96 drivingly engages lower surface 94 of first portion 92, thereby causing first portion 92 to be moved upwardly and downwardly. The upward and downward movement of first portion 92, along with the lateral movement of print carriage 74 along print carriage track 81 allows the print region 26 of cartridge 14 to be moved with respect to the intersection of wave image 84 and light sheet 88.

The movement of print carriage 74 along print carriage track 81 provides positioning or translation of cartridge 14 and, therefore, print volume 26 in a y direction. The vertical movement of first portion 92 provides positioning or translation of cartridge 14 and, therefore, print volume 26 in a z direction. Print carriage 74 may also be moved in a direction orthogonal to print carriage track 81 to provide positioning or translation of cartridge 14 and, therefore, print volume 26 in an x direction.

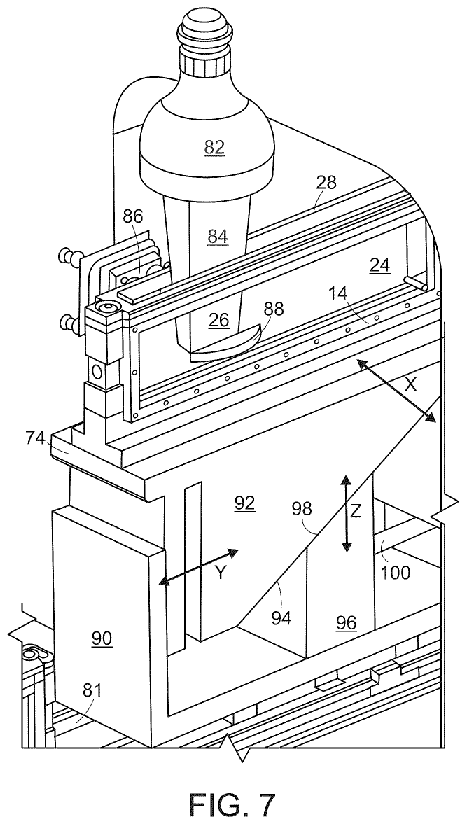

Thus, cartridge 14 is moved with respect to the intersection of image 84 and light sheet 88 as needed to form the desired 3D object in the first print region 26 of cartridge 14. Following the printing of a 3D object within the first print region 26, additional 3D objects may be formed in the remaining print regions 26 of cartridge 14. As illustrated in FIGS. 5 and 6, printing is shown being performed in a first or innermost print region 26. FIG. 7 illustrates printing in fourth print region 26. In the illustrated embodiment of FIGS. 5-7, cartridge 14 includes five (5) print regions 26 in which 3D objects are printed. As noted above, cartridge 14 can include any desired number of print regions. Once a 3D object has been printed in each print region 26, print carriage 74 may be moved laterally back out of printer assembly 60.

It is to be appreciated that in other embodiments, the intersection region of the image 84 and light sheet 88 may be moved by moving primary light source 82 and secondary light source 86 with respect to cartridge 14.

Other exemplary printers that may be used in printing assembly 50 are discussed in International Application No. PCT/US2022/039766 of Quadratic 3D, Inc. filed Aug. 9, 2022 for “Methods And Systems For Forming An Object In A Volume Of A Photohardenable Composition”, and U.S. Provisional Application No. 63/287,510 of Quadratic 3D, Inc. filed Dec. 8, 2021 for “Volumetric Three-Dimensional Printing Methods Including a Combined Light Sheet And Systems,” each of which is incorporated herein by reference. Optionally, a printer can further include from one to three additional light sheet generating systems (e.g., including a light source having same wavelength as the first light sheet and a light-sheet generator) for generating and directing one to three additional light sheets into cartridge 14 orthogonal to the first light sheet to intersect with the first light sheet and image at the same distinct location in cartridge 14. The wavelengths of any additional light sheets can be same or different as the wavelength of the first light sheet.

In the systems and methods disclosed herein, the selection of wavelength(s) of the excitation light for the excitation light projections is preferably made taking into account the photohardenable composition and hardening mechanism being used. For example, for photohardenable compositions that are hardenable via a hardening mechanism that involves a single wavelength of excitation light, one or more excitation light projections having the same wavelength may be used. Optionally in such cases, an excitation light projection including a different wavelength light can also be included, for example, for inhibiting undesired hardening of the photohardenable composition.

In cases where a photohardenable composition is hardenable via a hardening mechanism that involves more than one wavelength of excitation light, the wavelengths of the excitation light projections will be selected for projecting excitation light with appropriate wavelengths for the hardening mechanism. Optionally, an additional wavelength light can also be used to inhibit undesired hardening of the photohardenable composition.

The systems and methods disclosed herein may be useful with other 3D printing techniques that include initiation of a photochemical reaction in a photoreactive system via the absorption of light energy supplied by one or more excitation light projections to form an object. Examples include tomographic printing, two-photon printing, upconversion printing, and dual-wavelength printing.

As described above with respect to FIGS. 3-4, after the just-printed cartridge 14 has been moved out of printer assembly 60 it is then moved to basket platform 80 at the same time that a ready-for-printing cartridge 14 is moved from array 12 to print carriage 74. Cartridge 14 may then be removably secured to basket platform 80 by cartridge anchoring assemblies 75.

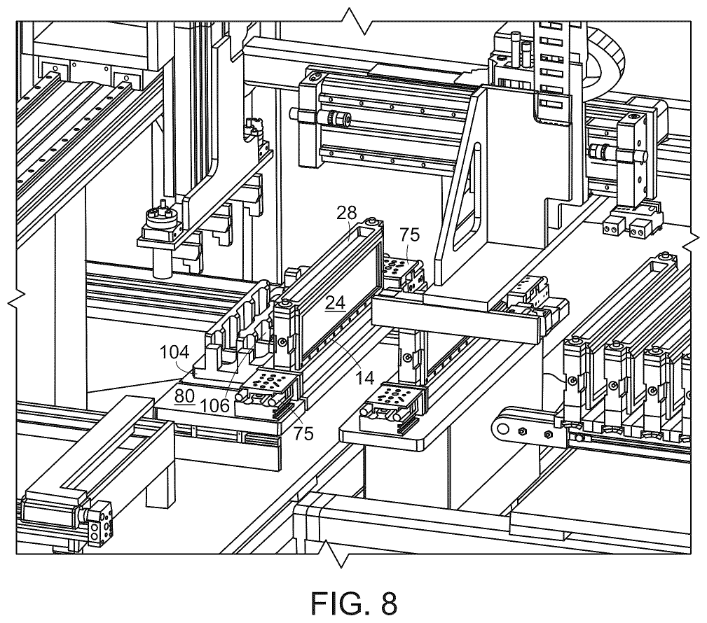

Basket platform 80 may then be moved along the printing process by a servo slide 102 that serves to properly position cartridge 14. As seen in FIG. 8, a basket carriage 104 is positioned just downstream of cartridge 14, and an empty basket may be seated in a first position 106 of basket carriage 84.

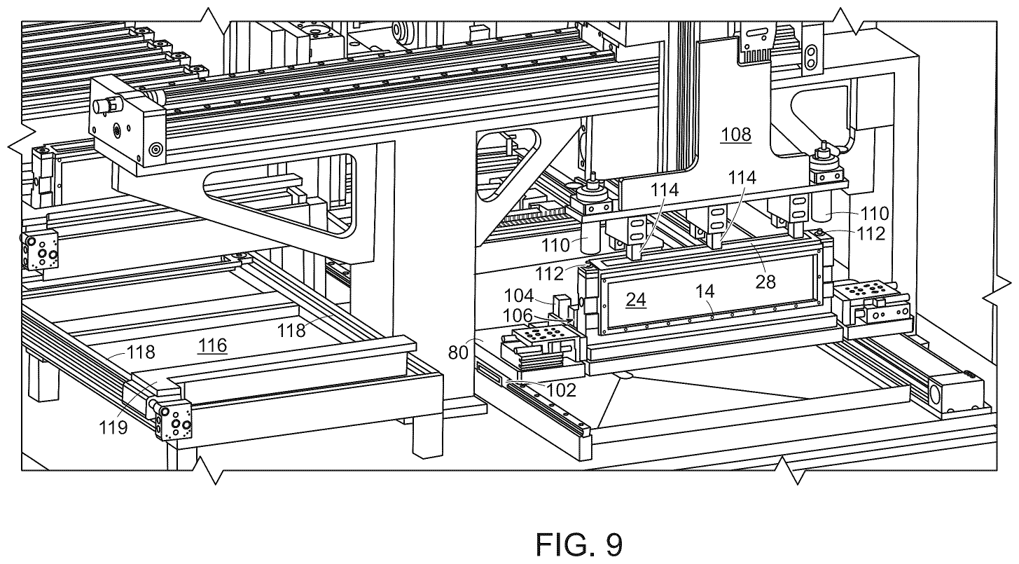

Cover 28 is then removed from cartridge 14, as illustrated in FIG. 9. A cover gripping assembly 108 may include a pair of cylindrical grippers 110, each of which grasps and turns a corresponding fastener 112 that secures cover 28 to cartridge 14. In the illustrated embodiment, fasteners 112 are quarter turn fasteners that are released by cylindrical grippers 110. Cover gripping assembly 108 may include one or more cover grippers 114 that grasp cover 28. Once cylindrical grippers 110 release fasteners 112, cover gripping assembly 108 may remove cover 28 from cartridge 14 and then move it laterally to a cover collection tray 116, at which point cover 28 is lowered into collection tray 116 and cover grippers 114 release cover 28. Cover collection tray 116 may include a pair of opposed cover rails 118 along which a plurality of covers 28 may be moved downstream within cover collection tray 116 by a pneumatic slide 119 for later collection, cleaning, and reuse.

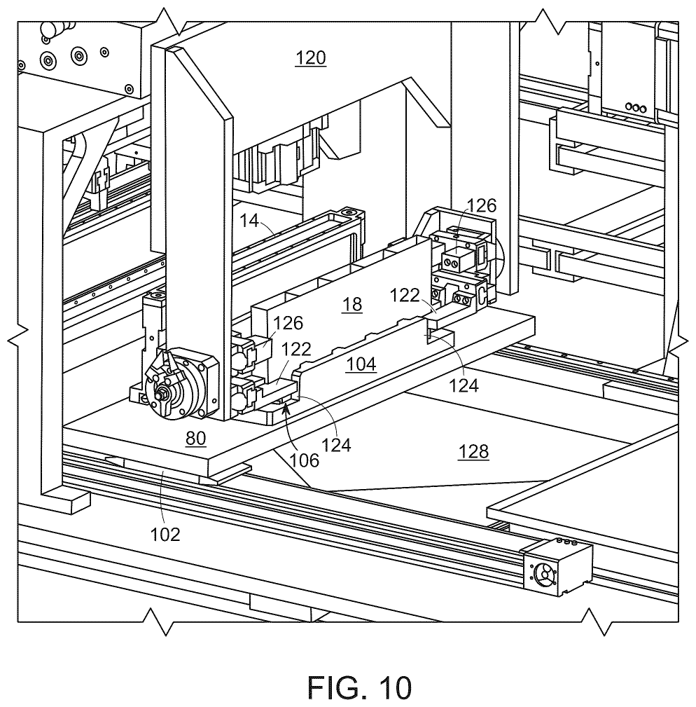

FIG. 10 illustrates movement of the empty basket 18 from first position 106 in basket carriage 104 into the just-printed cartridge 14 on basket platform 80, and is viewed here from the opposite side of the process as compared to FIGS. 3-9. As seen here, a cartridge flipping assembly 120 may include a pair of basket grippers 122 that grasp basket 18, which is positioned in basket carriage 104 in an upright position with open end 20 facing upwardly. A pair of cutouts 124 formed in basket carriage 124 may allow basket grippers 122 to grasp basket 8 18 proximate a bottom edge thereof.

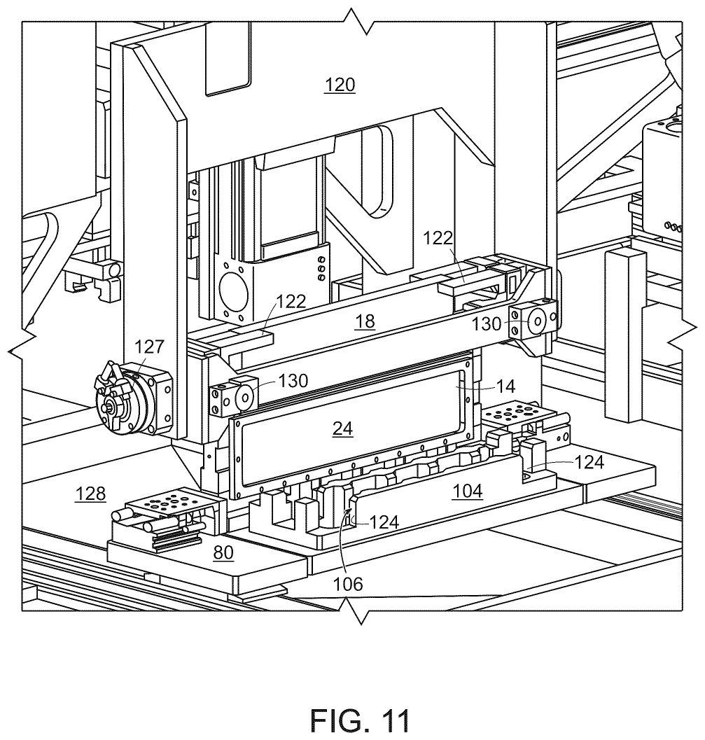

Cartridge flipping assembly 120 then raises basket 18 out of basket carriage 104, rotates basket 18 to an inverted position with open end 120 facing downwardly, moves basket 18 in position above cartridge 14, and lowers basket 18 into cartridge 14, as illustrated in FIG. 11. It is to be appreciated that cartridge flipping assembly 120 may be controlled by a servo motor that allows fine control of the movement of cartridge flipping assembly 120 to help prevent damage to 3D objects within cartridge 14 and basket 18.

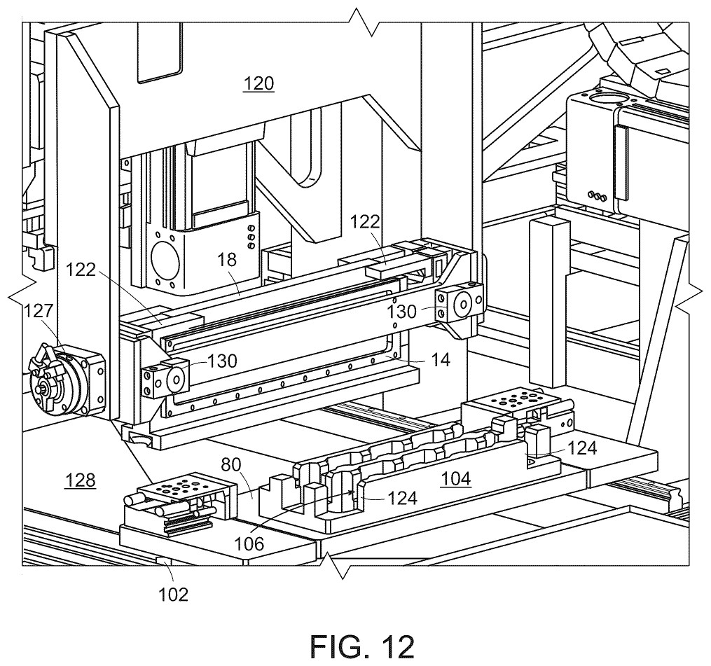

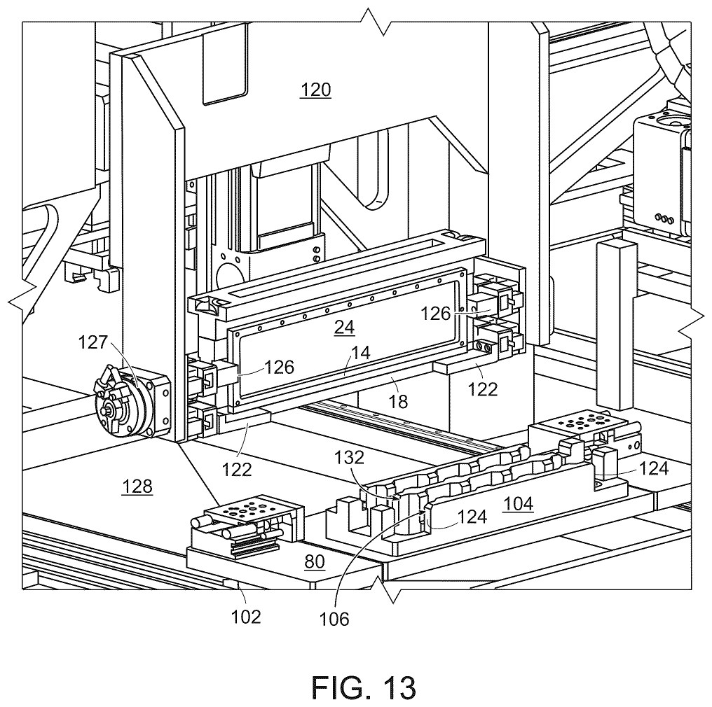

Once basket 18 is fully inserted into cartridge 14, a pair of cartridge grippers 126, visible in FIGS. 10 and 13, of cartridge flipping assembly 120 grasp cartridge 14. Cartridge 14 is released from basket platform 80, and cartridge flipping assembly 120 raises cartridge 14 and basket 18 upwardly away from basket platform 80, as seen in FIG. 12. Basket platform 18 is then moved upstream away from cartridge flipping assembly 120.

As illustrated in FIG. 13, cartridge flipping assembly 120 then rotates cartridge 14 and basket 18 with a pneumatic rotary cylinder 127 such that cartridge 14 is in an inverted position and basket 18 is in an upright position, causing resin 24 that has not hardened into a 3D object to flow and/or drip out of cartridge 14, which has no cover, and through basket 18, leaving the 3D objects seated within basket 18. Resin 24 flows out of cartridge 14 downwardly into a drip pan 128. Resin 24 collected in drip pan 128 may be collected and reused to refill an empty cartridge 14 before being covered and returned to array 12.

As seen in FIG. 12, cartridge flipping assembly 120 may include vibrators 130, which may be pneumatically powered, that can apply a vibrating or shaking force to cartridge flipping assembly 120, which may help to loosen or dislodge resin 24 within cartridge 14 so that it flows more easily out of cartridge 14 into drip pan 128. Cartridge 14 may be suspended in this inverted position for a pre-determined period of time to ensure that all of resin 24 has flown out of cartridge 14.

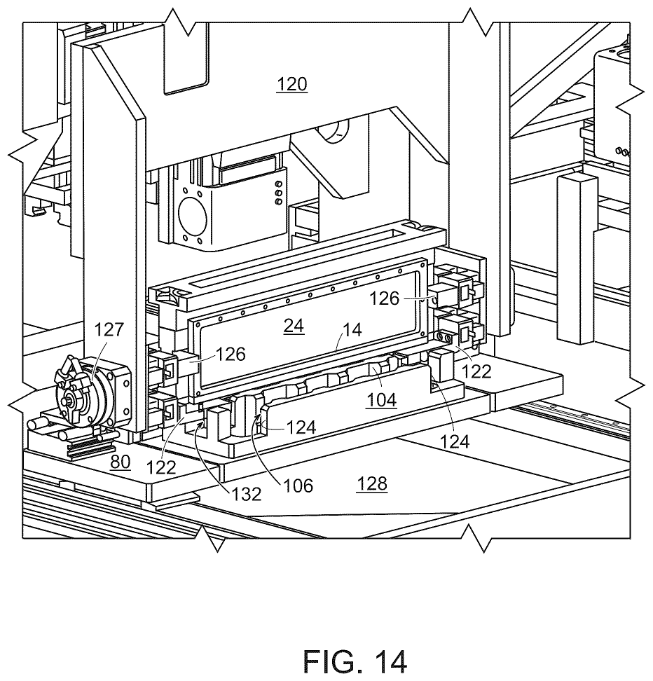

As illustrated in FIG. 14, basket platform 80 is then moved beneath cartridge flipping assembly 120, and basket 18 is lowered into a second position 132 within basket carriage 104. Second position 132 has a depth that is less than that of first position 106. Grippers 122 then release basket 18 and cartridge flipping assembly 120 is raised slightly, at which point grippers 122 grasp basket 18 at a higher point so as to expose more of basket 18 below grippers 122. Cartridge flipping assembly 120 is then raised, basket platform 80 is moved slightly so that basket 18 is positioned over first position 106, and basket 18 is lowered into first position 106 of basket carriage 104. As noted above, first position 106 of basket carriage 104 is deeper than second position 132, providing more support for the sidewalls of basket 18 as it proceeds through the rest of the process, thereby helping maintain basket 18 in a stable position and helping prevent tipping of basket 18.

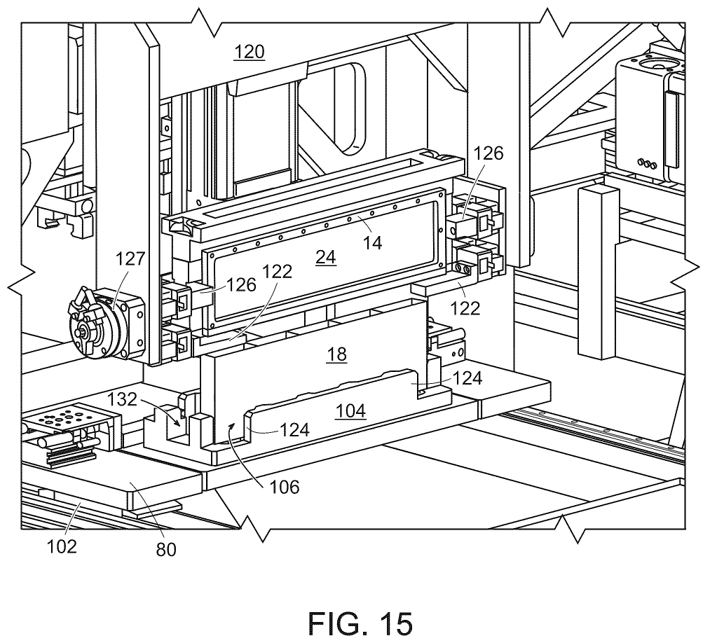

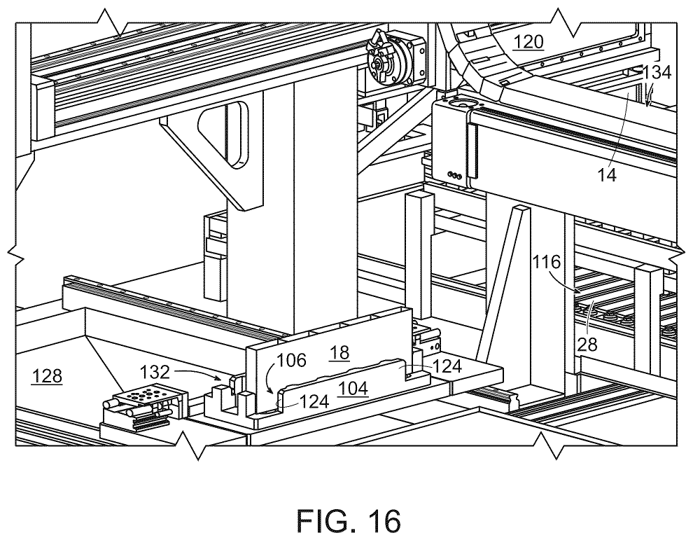

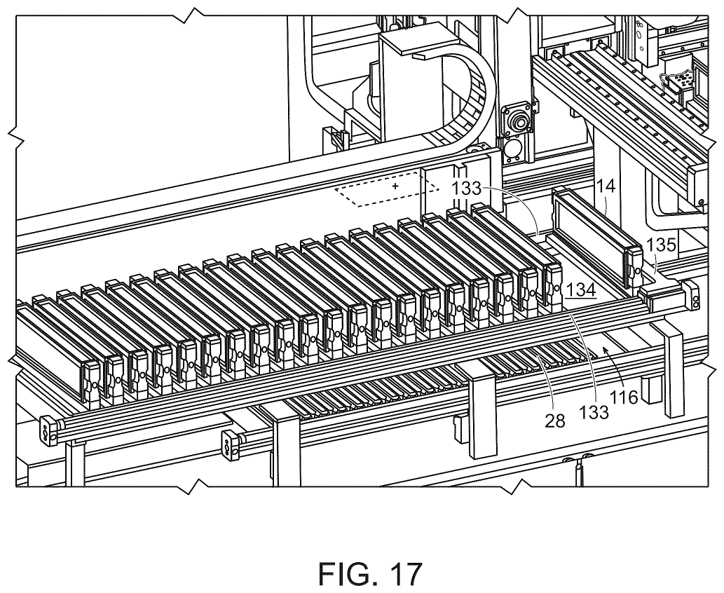

Cartridge flipping assembly 120 then raises empty cartridge 14 in its inverted position, leaving basket 18 with 3D objects seated therein positioned within first position 106 of basket carriage 104, as seen in FIG. 15. Cartridge 14 is then rotated back to its upright position and moved laterally out of the printing process to a cartridge collection tray 134, as seen in FIGS. 16-17. Cartridge collection tray 134 may be positioned above cover collection tray 116, and may include a pair of opposed cartridge rails 133 along which a plurality of cartridges 14 may be moved downstream within cartridge collection tray 134 by a pneumatic slide 135 for later collection, cleaning, and reuse. It is to be appreciated that cartridges 14 and covers 28 may be collected by an automated handling system or by an operator and subsequently cleaned and refilled and returned to array 12, or disposed of.

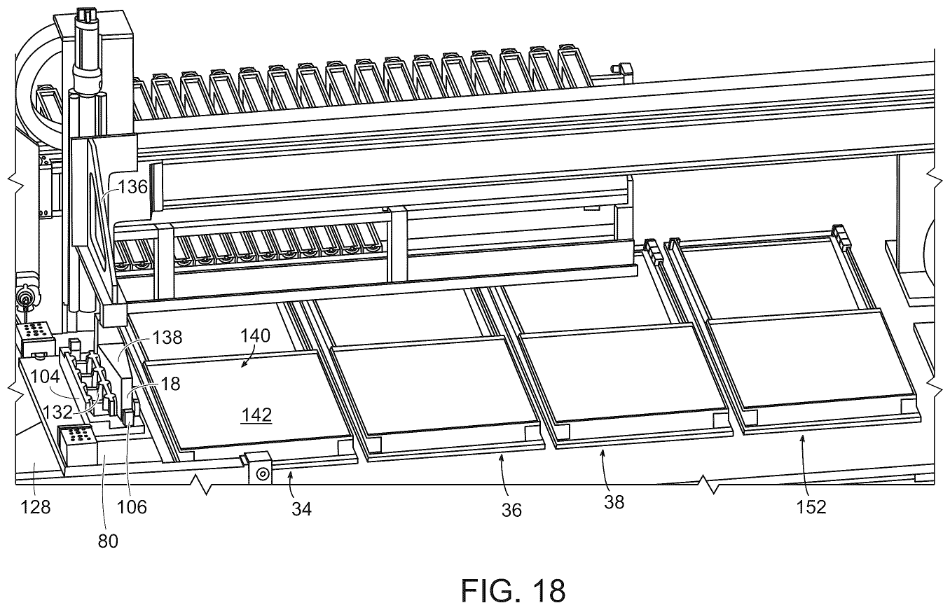

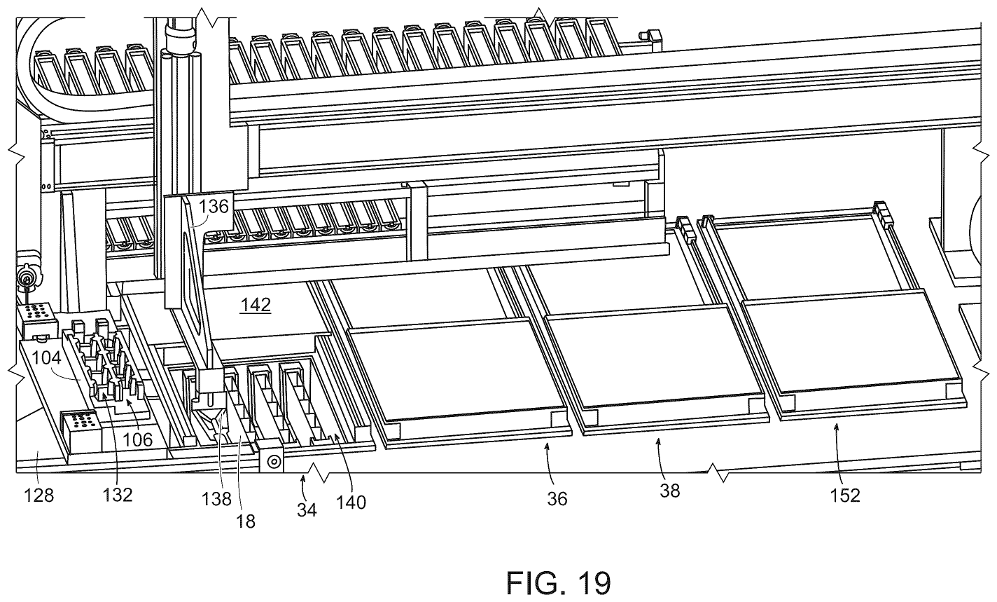

As illustrated in FIGS. 18-21, a basket gripping assembly 136 may include one or more basket grippers 138 that may raise basket 18, including 3D objects seated therein, out of basket carriage 104 for finishing steps. First washing station 34 may include a first wash basin 140 and a cover 142, which may be moved laterally to expose first wash basin 140. Basket gripping assembly 136 may then move basket 18 into any open and unoccupied position within first wash basin 140, as illustrated in FIG. 19. The 3D objects within basket 18 may then undergo a first cleaning within first wash basin 140. A cleaning solution such as a solvent may be used to rinse and clean the 3D objects in first wash basin 140. The cleaning solution used in first wash basin 140 may be any suitable organic or aqueous wash liquid, including solutions, suspensions, emulsions, microemulsions, etc. Examples of suitable wash liquids include, but are not limited to water, alcohols (e.g., methanol, ethanol, isopropanol, etc.), glycol ethers, esters (i.e., dimethyl adipate), benzene, toluene, etc. Wash liquids including a mixture of two or more liquids (e.g., water and an alcohol (e.g., isopropanol) may also be suitable. Such wash solutions may optionally contain additional constituents such as surfactants, etc. In certain embodiments, first wash basin 140 may include jets and/or nozzles (not shown) to direct high pressure cleaning solution onto the 3D objects, and may include heating elements or ultrasonic sources to improve the speed or completeness of the cleaning process. In certain embodiments, first wash basin 140 may include mechanical agitation or stirring elements (not shown) to assist in removing resin 24 from the 3D objects.

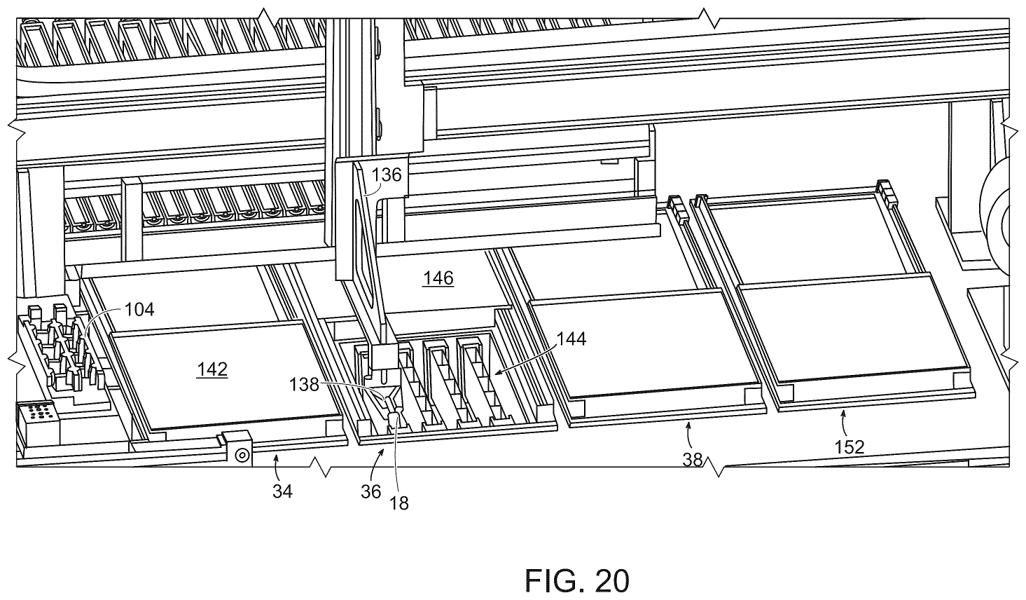

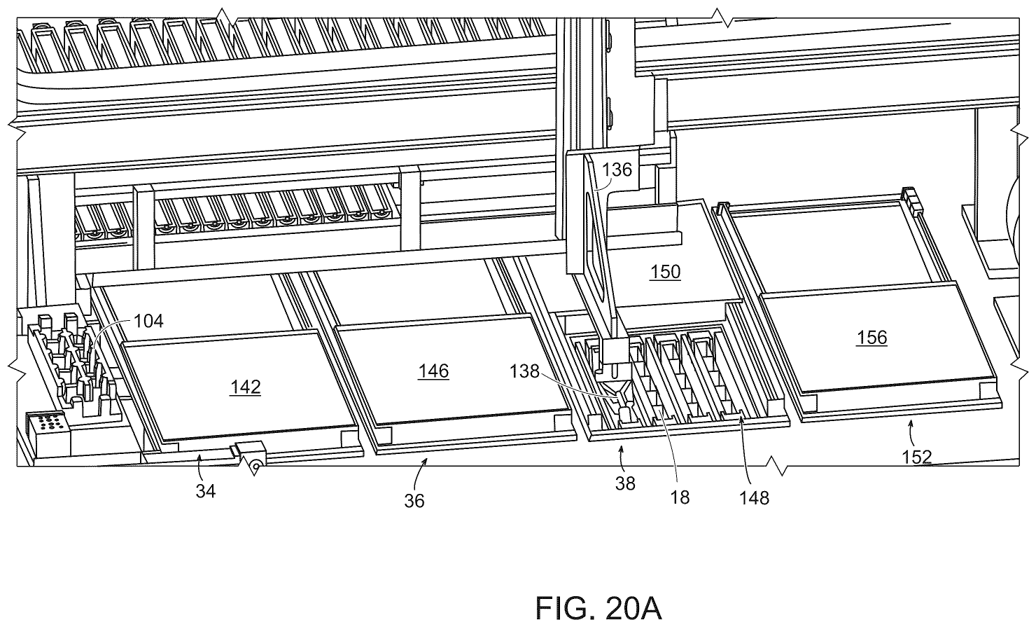

Basket gripping assembly 136 may then move basket 18 out of first wash basin 140 to second washing station 36, which may include a second wash basin 144 and a cover 146, which may be moved laterally to expose second wash basin 144. Basket gripping assembly 136 may move basket 18 into any open and unoccupied position within second wash basin 144, as illustrated in FIG. 20. The 3D objects within basket 18 may then undergo a second cleaning within second wash basin 144. A cleaning solution such as a solvent may be used to rinse and clean the 3D objects in second wash basin 144. The cleaning solution used in second wash basin 144 may be any suitable organic or aqueous wash liquid, including solutions, suspensions, emulsions, microemulsions, etc. Examples of suitable wash liquids include, but are not limited to water, alcohols (e.g., methanol, ethanol, isopropanol, etc.), glycol ethers, esters (i.e., dimethyl adipate), benzene, toluene, etc. Wash liquids including a mixture of two or more liquids (e.g., water and an alcohol (e.g., isopropanol) may also be suitable. Such wash solutions may optionally contain additional constituents such as surfactants, etc., which may be the same as, or different than, the cleaning solution used in first wash basin 140. In certain embodiments, second wash basin 144 may include jets and/or nozzles (not shown) to direct high pressure cleaning solution onto the 3D objects, and may include heating elements or ultrasonic sources to improve the speed or completeness of the cleaning process. In certain embodiments, second wash basin 144 may include mechanical agitation or stirring elements (not shown) to assist in removing resin 24 from the 3D objects.

As baskets are seated in first wash basin 140 and second wash basin 144 they may go through repeated cleaning cycles. Baskets 18 may be transferred from first wash basin 140 to second wash basin 144 after any desired number of cleaning cycles.

After basket 18 has been cleaned in second wash basin 144, basket gripping assembly 136 may then move basket 18 out of second washing basin 140 to drying station 38, which may include a drying basin 148 and a cover 150, which may be moved laterally to expose drying basin 148, as illustrated in FIG. 20A. Basket gripping assembly 136 may move basket 18 into any open and unoccupied position within drying basin 148. The 3D objects within basket 18 may then undergo a drying process within drying basin 148.

After basket 18 has been dried in drying basin 148, basket gripping assembly 136 may then move basket 18 out of drying basin 148 to a pre-curing station 152, which may include a pre-curing basin 154 and a cover 156, which may be moved laterally to expose pre-curing basin 154, as illustrated in FIG. 21. Basket gripping assembly 136 may move basket 18 into any open and unoccupied position within pre-curing basin 154. The 3D objects within basket 18 may then undergo an initial curing process within pre-curing basin 154.

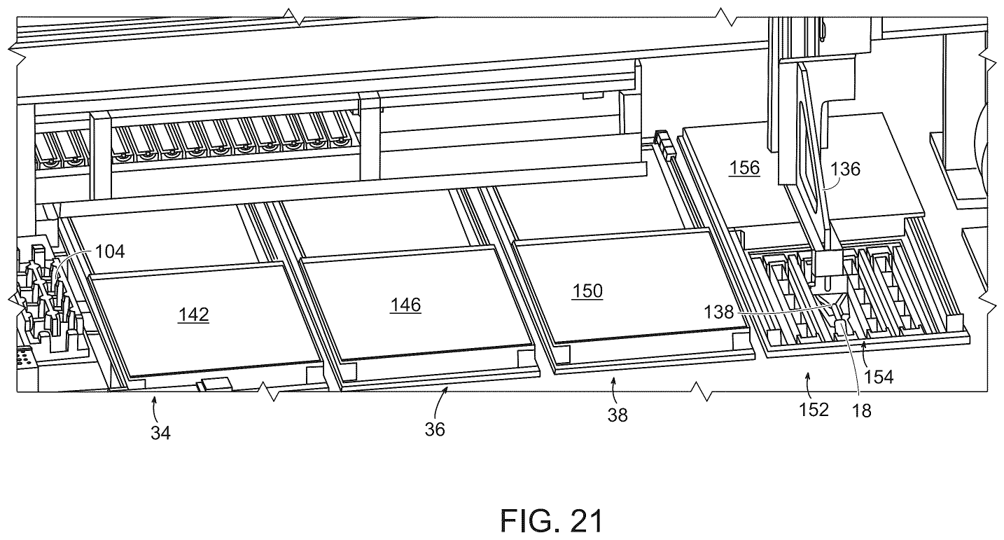

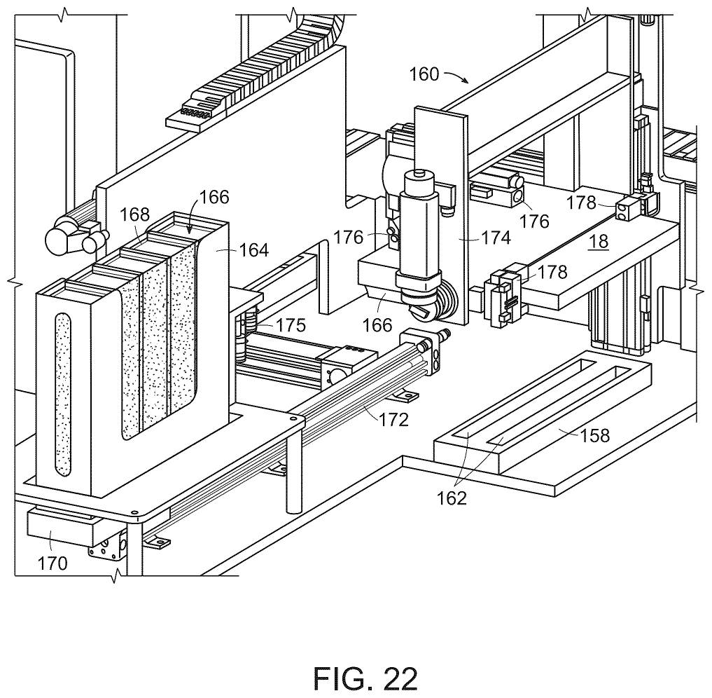

After pre-curing has been completed in pre-curing basin 154, basket gripping assembly 136 may move basket 18, with cleaned, dried, and pre-cured 3D objects seated therein, downstream to a basket housing 158 of a transfer assembly 160, seen in FIG. 22, from the opposite side of the process. Transfer assembly 160 operates to transfer the 3D objects from basket 18 to curing trays for further processing, as described in greater detail below.

Basket housing 158 may have two recesses 162 formed therein, and basket gripping assembly 136 may move basket into an empty one of the two recesses 162. After the 3D objects have been transferred out of basket 18, the empty basket is returned to one of the empty recesses 162. When basket 18 is empty, basket gripping assembly 136 may grasp the empty basket 18 and return it upstream to first position 106 in basket carriage 104, as shown in FIG. 8. Optionally, empty basket 18 can be cleaned before being returned to basket carriage 104.

As illustrated in FIG. 22, A magazine 164 in which a plurality of curing trays 166 is seated may be positioned laterally with respect to transfer assembly 60. Each curing tray 166 may have a plurality of compartments 168, each of which will receive an individual 3D object from basket 18. In the illustrated embodiment, each curing tray 166 includes five (5) compartments. It is to be appreciated that curing tray 166 can have one or any other number of compartments, and that the number of compartments may be larger than the number of 3D objects seated within basket 18.

A first transfer carriage 170 is configured to move laterally along a transfer rail assembly 172 from beneath magazine 164 into the process stream under a transfer arm 174 of transfer assembly 160. Transfer arm 174 may be controlled by a servo motor that allows fine control of the movement of transfer arm 174 to help ensure that the 3D objects are not damaged during their transfer out of basket 18 into curing tray 166.

An inspection camera 175 may be included to inspect the cartridge throughout the printing process. In one embodiment, it may be positioned adjacent magazine 164. As curing trays 166 move laterally in transfer carriage 170 past inspection camera 175, a picture can be taken of a label, such as a barcode, positioned in each compartment 168 of curing tray 166. This helps the system track the individual 3D objects placed in a particular compartment 168 of curing tray 166.

To start the transfer process, a curing tray 166 is dropped into first transfer carriage 170, and transfer carriage moves laterally to a position beneath transfer arm 174 (not shown here). Transfer arm 174 is then lowered, and one or more tray grippers 176 grasp and lift an empty curing tray 166 out of first transfer carriage 170. As illustrated in FIG. 22, transfer arm 174 is holding curing tray 166 after having removed it from first transfer carriage 170.

One or more basket grippers 178 of transfer arm 174 then grasp basket 18 in which 3D objects are seated, lifts basket 18 from basket housing 158, rotates basket 18 and curing tray 166. As illustrated in FIG. 22, basket 18 has been lifted out of basket housing 158, and been rotated 90° from its position within basket housing 158.

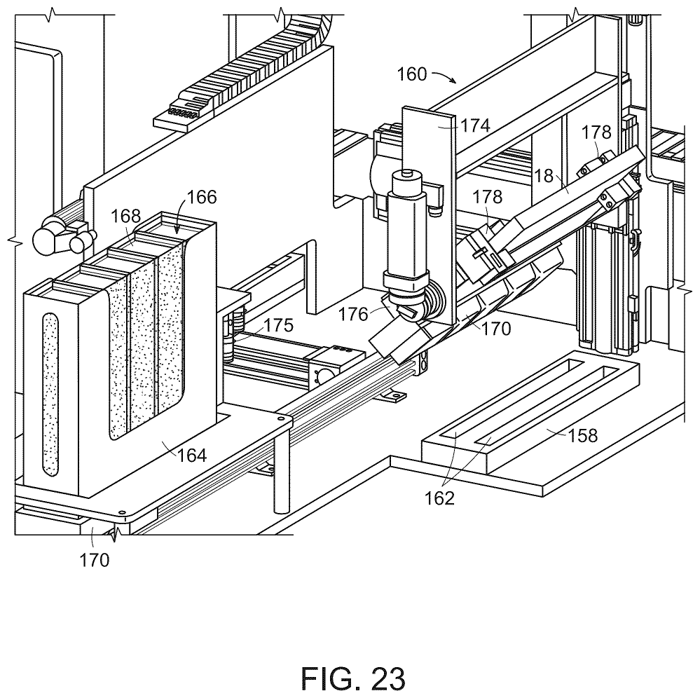

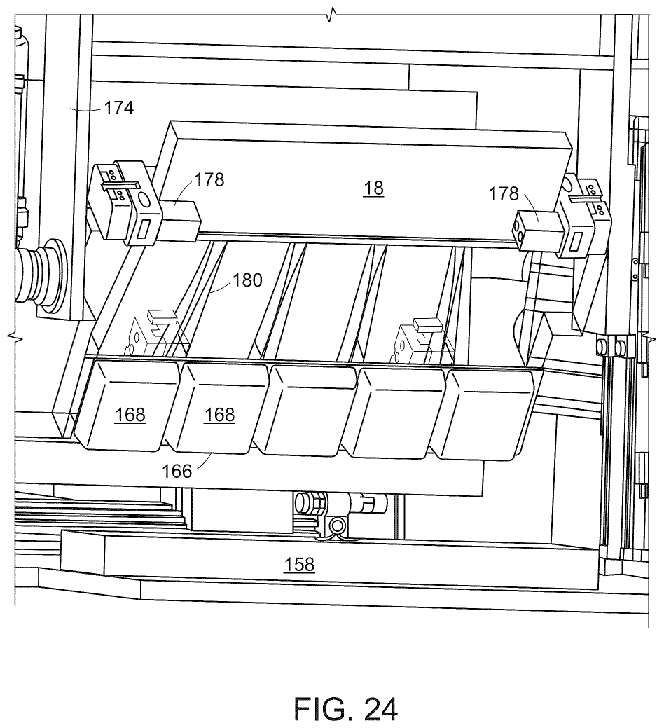

As seen in FIG. 23, transfer arm 174 continues to rotate basket 18 and curing tray 166, such that the 3D objects within basket 18 slide down into corresponding compartments 168 in curing tray 166. In certain embodiments, as illustrated in FIG. 24, transfer arm 174 may include a plurality of separator walls 180 that serve to guide the 3D objects as they slide out of basket 18 into compartments 168 of curing tray 166. It is to be appreciated that separator walls 180 are positioned within the interior of transfer arm 174 and are not visible from the exterior of transfer arm 174, but are shown here for purposes of clarity and understanding.

As noted above, transfer arm 174 may be controlled by a servo motor. In the event that the 3D objects do not freely travel from basket 18 into curing tray 166, transfer assembly arm 174 can be jostled and/or shaken to help the 3D objects move out of basket 18 into curing tray 166.

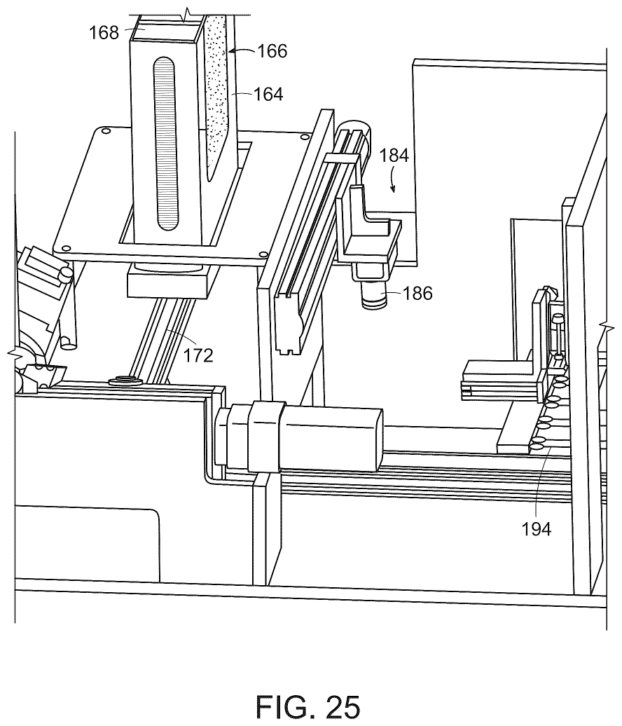

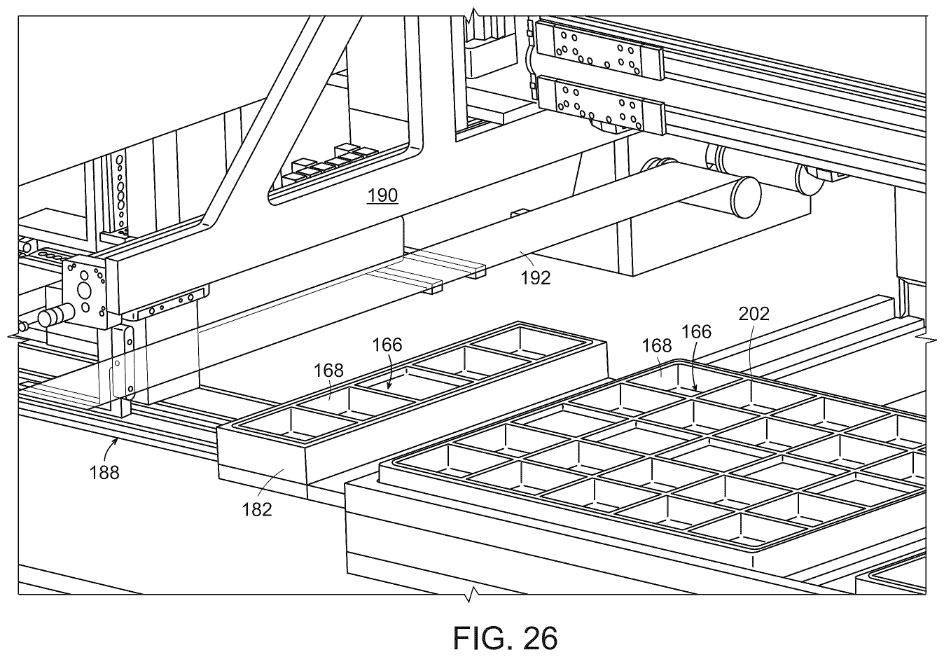

Once the 3D objects have been moved into curing tray 166, transfer arm 174 rotates until curing tray 166 is in an upright position (as seen in FIG. 22), and curing tray 166 is then placed on a second transfer carriage 182 (seen in FIG. 26). Second transfer carriage 182 then moves downstream to an inspection assembly 184 that may include a camera 186, as seen in FIG. 25. Camera 186 may cycle side-to-side and may be used to count and/or inspect the 3D objects as they pass through inspection assembly 184. It is to be appreciated that second transfer carriage 182 and the curing tray 166 seated therein are not visible in FIG. 25.

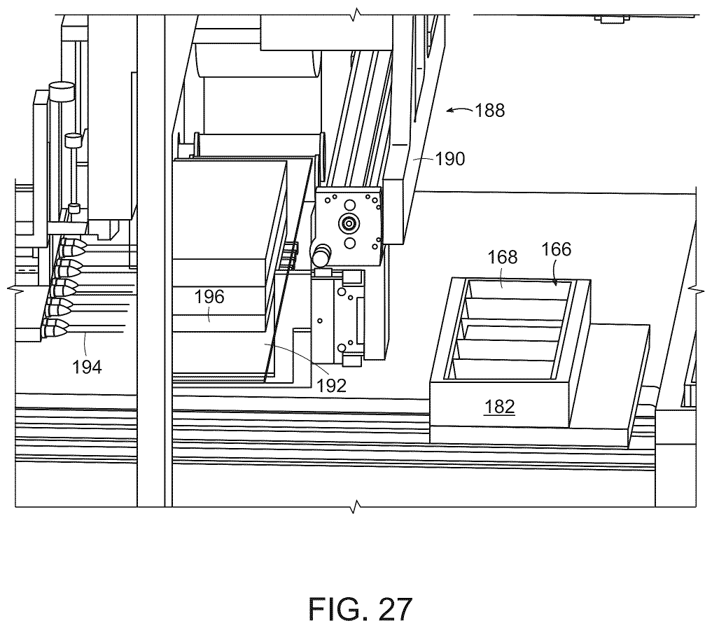

After inspection of the 3D objects is complete, second transfer carriage 182 is moved to a sealing station 188, illustrated in FIGS. 26-27, where curing tray 166 with 3D objects therein is sealed. Components of a sealing arm 190 operate to stretch a sealing film 192 horizontally above open curing tray 166 in a direction perpendicular to the process flow direction. Sealing film 192 is then lowered onto the top of curing tray 166, while one or more needles 194 are positioned between sealing film 192 and curing tray 166. FIG. 27 illustrates needles 194 in a retracted positioned upstream of sealing arm 190 after curing tray 166 has been sealed and moved downstream from sealing station 188.

Needles 166 serve to inject argon or any other inert gas into compartments 168 of curing tray 166, which displaces oxygen out of curing tray 166. As sealing film 192 is lowered onto the top edge of curing tray 166, a heat sealing plate 196 lowered onto sealing film 192 and presses sealing film 192 against the top surface of curing tray 166, thereby heat sealing the top of curing tray 166 with 3D objects seated therein. It is to be appreciated that after the inert gas has been injected into compartments 168 of curing tray 166, needles 194 are retracted. As needles 194 are retracted, any voids where needles 194 were positioned are sealed by sealing film 192, thereby completely sealing curing tray 166.

After curing tray 166 has been sealed, it may move downstream to a labelling station (not shown), where one or more labels may be affixed to curing tray 166. The labels may be barcodes or any other suitable label. It is to be appreciated that a single label can be placed on each curing tray 166. In other embodiments, a plurality of labels can be placed on curing tray 166, with each label corresponding to a particular compartment 168 within curing tray 166. Suitable labels and locations for such labels will become readily apparent to those skilled in the art, given the benefit of this disclosure.

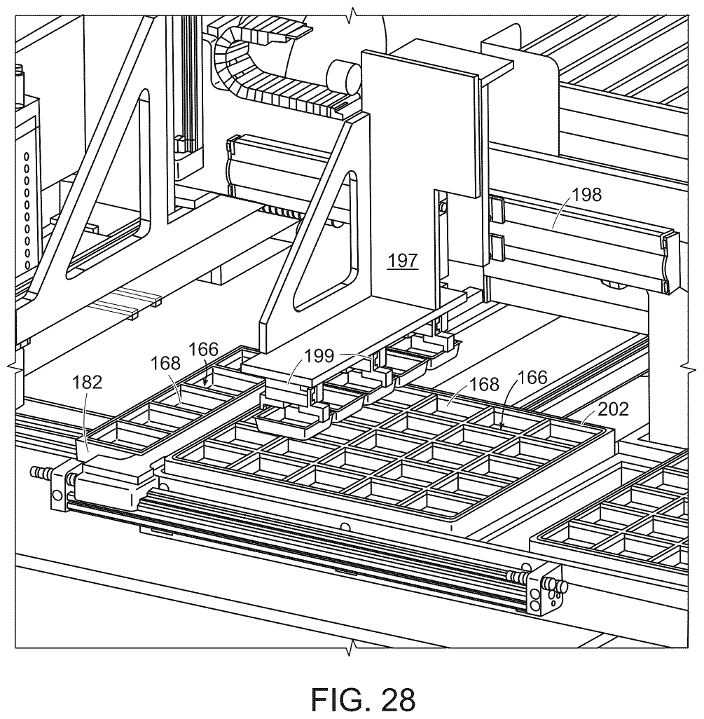

After labelling is complete, a curing transfer arm 197 may move along a transfer track 198 of a transfer assembly 200, as illustrated in FIG. 28. The transfer arm may include tray grippers 199 that lift curing tray 166 from second transfer carriage 182 and deposit curing tray in a transfer tray 202 where a plurality of curing trays may be seated. In the illustrated embodiment, five (5) curing trays 166 may be seated in each transfer tray 202, such that twenty-five (25) 3D objects are seated within each transfer tray 202.

Transfer tray 202 may then move downstream for curing and other post-curing processing. An empty transfer tray 202 can then be placed in position downstream of the labelling station for receiving additional curing trays 166.

Transfer tray 202 may then be transferred to a curing station (not shown). In some embodiments, the curing station could be in-line with printing process flow, and in such an embodiment, the curing station could be a tunnel through which transfer tray 202 passes. In other embodiments, a transfer assembly or an operator can take the full transfer tray 202 and move it to a curing oven.

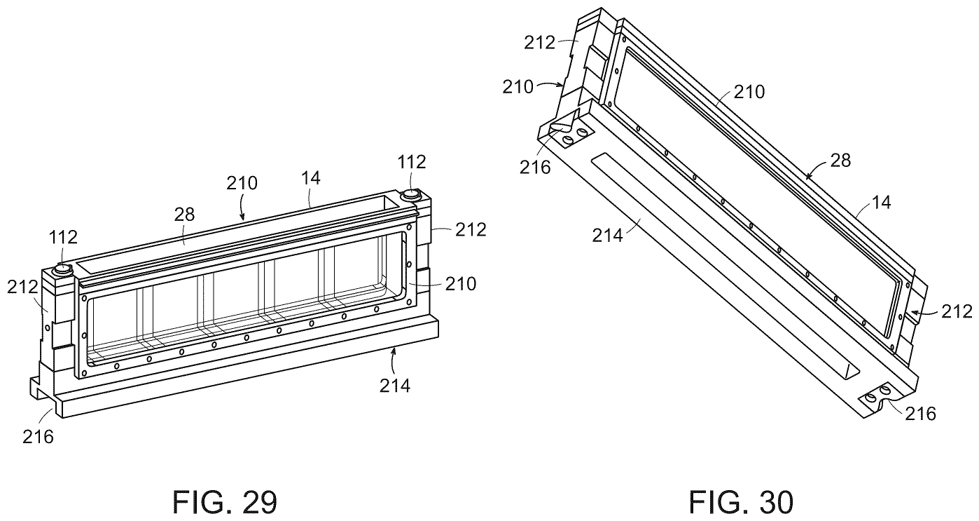

An exemplary cartridge 14 used in printing system 50 is seen in FIGS. 29-32. Cartridge 14, may include a housing that may be metal in certain embodiments, such as aluminum and stainless steel. Cartridge 14 may include cover 28, a pair of opposed sidewalls 210, a pair of opposed end walls 212, and a bottom 214. As discussed above, quarter turn fasteners 112 secure cover 28 to cartridge 14.

As noted above, cartridge 14 may include one or more transparent regions to allow the one or more wavelengths of excitation light to enter cartridge 14. For example, cover 28, sidewalls 210, end walls 212, and bottom 214 each may include fused quartz windows.

Alignment cleats 216 may be positioned at opposed ends of bottom 214 and cooperate with cartridge anchoring assemblies 75 to temporarily secure cartridge 14 to print carriage 74, as seen in FIG. 8.

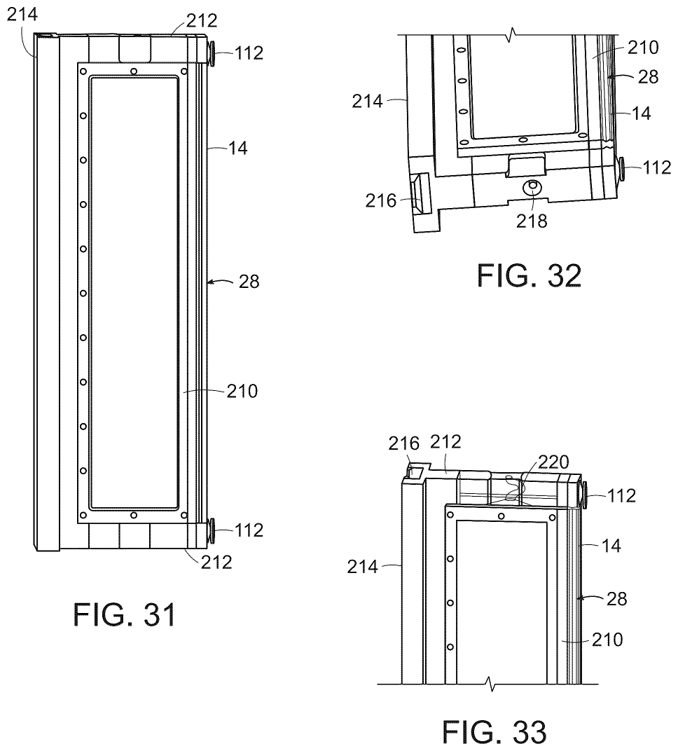

To fill cartridge 14, it is placed with one end wall 212 facing downwardly, as seen in FIG. 31. A pump (not shown) then injects resin 24 into cartridge 14 through a spring-loaded valve 218 formed in the downwardly facing end wall 212. As resin 24 fills cartridge 14, any air contained within cartridge 14 above the level of resin 24 may escape through an air trap 220 formed in the opposed end wall 212. Various embodiments of a volumetric 3D printing assembly and printing process have been described herein, which include various components and features. In other embodiments, the volumetric 3D printing assembly may be provided with any combination of such components and features. It is also understood that in other embodiments, the various devices, components, and features of the volumetric 3D printing assembly described herein may be constructed with similar structural and functional elements having different configurations, including different ornamental appearances.

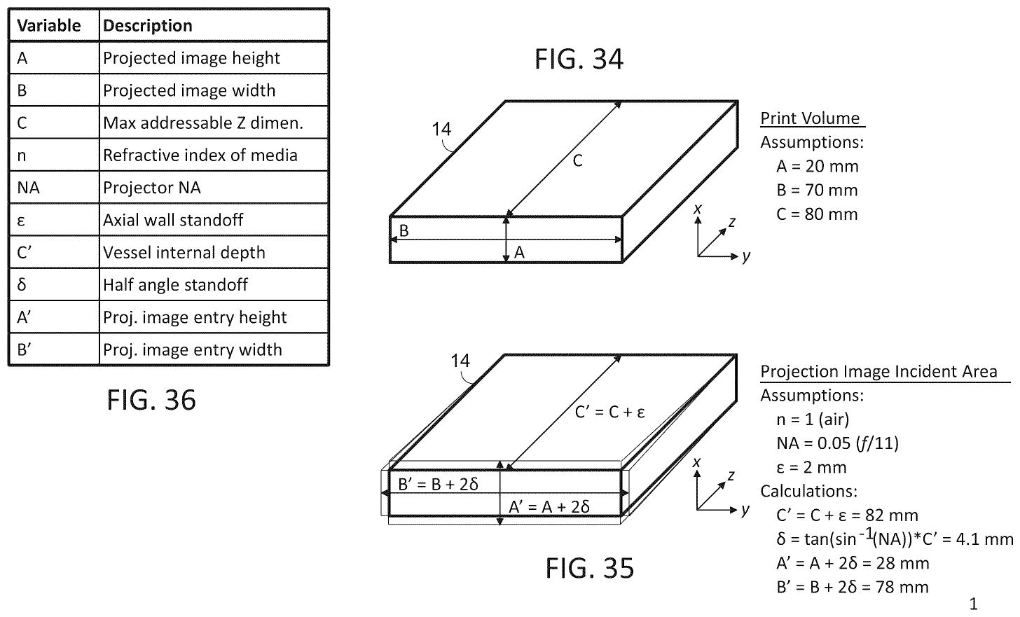

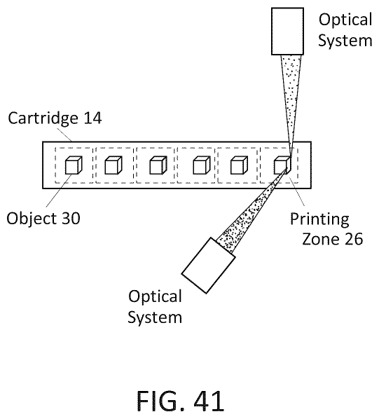

Additional embodiments of cartridge 14 are shown in FIGS. 34-41.

In certain embodiments, a system and/or method described herein may include a cartridge for printing one or more three-dimensional objects, the cartridge being configured to contain a volume of a photopolymerizable composition, the cartridge including side walls, preferably four, attached to a bottom wall to define a volume space for containing the volume, the cartridge being configured for including one or more printing zones, wherein a printing zone is sized to facilitate being irradiated by one or more, preferably at least two, excitation light projections to at least partially form a three-dimensional printed object within the volume of photopolymerizable composition in the printing zone.

A cartridge can be open. An open cartridge can further include a cover, which can be removable, for closing the cartridge. A cartridge can be closed, including a top wall opposite the bottom wall, in such case at least one of the walls can include at least one port in at least one of the walls for facilitating the introduction and/or removal of unpolymerized photopolymerizable composition and/or removal of one or more three-dimensional objects from the cartridge.

In certain other embodiments, a system and/or method described herein can include a cartridge for printing one or more three-dimensional objects, the cartridge being configured to contain a volume of a photopolymerizable composition, the cartridge including opposed end walls and including at least one port in at least one end wall of the cartridge for facilitating the introduction and/or removal of unpolymerized photopolymerizable composition and/or removal of one or more three-dimensional objects from the cartridge, the cartridge being configured for including one or more printing zones, wherein a printing zone is sized to facilitate being irradiated by one or more, preferably at least two, excitation light projections to at least partially form a three-dimensional printed object within the volume of photopolymerizable composition in the printing zone.

It may be desirable for an entire cartridge described herein to be optically transparent.

Alternatively, a cartridge described herein can include one or more optically transparent regions associated with a printing zone to facilitate directing excitation light projections into the printing zone through the one or more optically transparent regions.

For example, two optically transparent regions or sides can be included in a cartridge when a printing zone is addressed by two optical systems. When three optical systems address a printing zone, three optically transparent regions or sides can be included in a cartridge. Additional optically transparent regions or sides can optionally be included.

Preferably optically transparent region(s) of a cartridge is (are) also optically flat.

A cartridge can include a first port for the introduction of the photopolymerizable composition into the cartridge and a second port for the removal of unpolymerized photopolymerizable composition and/or one or more three-dimensional objects from the cartridge.

Inclusion of two ports, for example, can be also desirable for purposes of removal of the contents of a cartridge after printing. For example, two ports included at opposite end walls of a cartridge can facilitate applying pressure (e.g., by pumping air) or pumping a fluid into the cartridge through one port to transport the contents toward and through the exit port thereby removing/discharging the contents out of the cartridge through the second port.

A printing zone in a cartridge described herein preferably has dimensions that are determined taking into consideration the dimensions of the object to be printed, the numerical aperture characteristics of the projected light projections, the refractive index of the photopolymerizable composition (or a suitable alternative).

FIG. 34 depicts a diagram showing an example of the dimensions of a projected optical image: the projected image height, A; the projected image width, B; and the maximum addressable Z-dimension, C, for printing. In the depicted example, the assumed values A=20 nm, B=70 nm, and C=80 nm. These values are exemplary only and other values may be found to be suitable.

FIG. 35 depicts a diagram showing an example of the dimensions of a projection image incident area superposed over the projected optical image dimensions shown in FIG. 34 and the calculations for determining the dimensions of projected image incident area. Two times the half angle standoff 8 is used to determine the maximum projected dimensions of an optical system projection for one printing zone. The projected image entry height is represented by A′; the projected image entry width is represented by B′; the furthest (from incident face) projection plane depth is represented by C′; NA is the numerical aperture of the projection under consideration; and & is a distance chosen to separate the printing zone from the front and back walls of the vessel. These values are calculated using the following equations:

$$\begin{matrix}C ’ = C + ε \\ δ = tan ( {sin}^{- 1} ( N A ) ) * C ’ \\ A ’ = A + 2 δ \\ B ’ = B + 2 δ\end{matrix}$$

wherein:
n=refractive index of the media, e.g., photohardenable composition
NA=the numerical aperture of the projector
ε =axial wall standoff
δ=half angle standoff

In FIG. 1B:

The following Projection Image Incident Area assumptions are used in calculating A′, B′ and C′ in FIG. 1B:

$$\begin{matrix}n = 1 ( air ) \\ NA = 0.05 ( f / 11 ) \\ ε = 2 mm\end{matrix}$$

The values provided in FG. 35 for NA and & here are exemplary only and other values may be suitable. It should be noted that this same analysis may be carried out for each of the multiple optical projections into the printing volume, in the case that their dimensions and numerical apertures differ, and that the largest corresponding values of & be selected.

FIG. 36 is a legend describing the variables included in FIGS. 34 and 35.

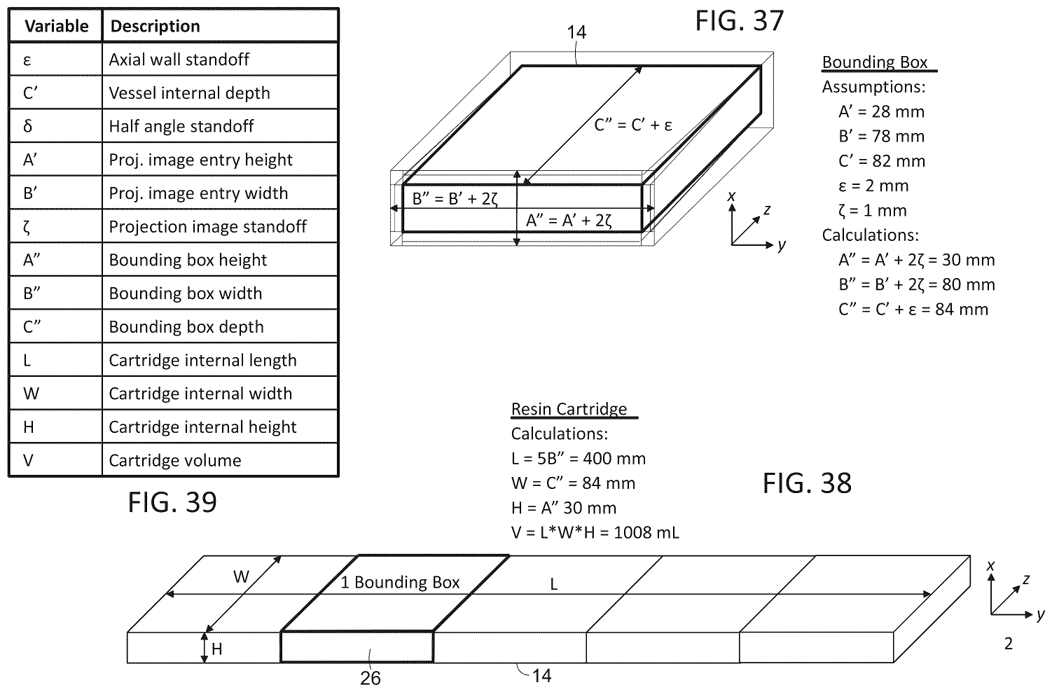

FIG. 37 depicts a diagram showing an example of the dimensions of a printing region or zone 26 (referred to in the FIG. as “Bounding Box”) superposed over the projection image incident area dimensions shown in FIG. 35 and the calculations for determining the printing zone (referred to in the FIG. as “Bounding Box”) dimensions. The Bounding Box height is represented by A″; the Bounding Box width is represented by B″; the Bounding Box depth is represented by C″; and ζ is a distance chosen to separate the printing zone from adjacent printing zone(s). These values are calculated using the following equations:

$$\begin{matrix}A ” = A ’ + 2 ζ \\ B ” = B ’ + 2 ζ \\ C ” = C ’ + ε\end{matrix}$$

wherein:
NA=the numerical aperture of the projector
ε=axial wall standoff
C′=cartridge internal depth
δ=half angle standoff
A′=projected image entry height
B′=projected image entry width
ζ=projection image standoff
A″=bounding box height
B″=bounding box width
C″=bounding box depth
L=cartridge internal length
W=cartridge internal width
H=cartridge internal height
V=cartridge volume
n=refractive index of the media, e.g., photohardenable composition

In FIG. 37:

The following Bounding Box Assumptions are used in calculating A″, B″, and C″ for FIG. 2B:
A′=28 mm
B′=78 mm
C′=82 mm
ε=2 mm
ζ=1 mm.

FIG. 38 depicts an example of a cartridge 14 designed to include multiple printing regions or zones 26 (referred to in the FIG. as “Bounding Box”). As depicted, the cartridge 14 includes five (5) printing zones 26. The dimensions of the depicted cartridge 14 (including five printing zones 26) for the values shown in FIGS. 34, 35, 36, and 37 are: Cartridge internal length is represented by L; cartridge internal width is represented by W; and cartridge internal height is represented by H. Cartridge internal length takes into account the selected number of printing zones to be included in the cartridge. The calculated internal volume of the cartridge is the product of L×W×H.

FIG. 39 is a legend describing the variables included in FIGS. 37 and 38.

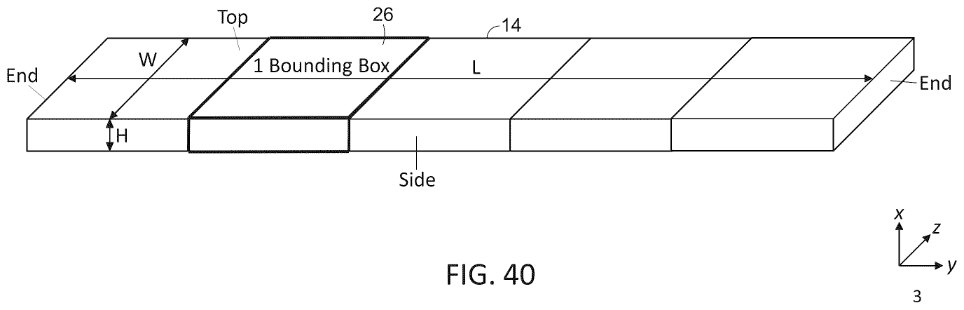

FIG. 40 depicts an example of a cartridge 14 including five printing zones 26 and identifies the top wall, the opposed end walls. The bottom wall opposite the top wall and the side wall opposite the labeled side wall are not shown. It can be desirable for optical projections to be irradiated into a printing zone through one or more of a top wall, bottom wall, and either side wall.

Preferably, when more than one printing zone is included in a cartridge to accommodate the formation of a plurality of objects in the same cartridge, the printing zones are sized to prevent objects printed in adjacent printing zones from touching each other during printing.

Optionally, a partition can be included between printing zones to provide further protection against unwanted polymerization in an adjacent printing zone when multiple printing zones are included in a cartridge. When included, it can be desirable for any such partitions to be removable to facilitate emptying a cartridge after printing.

Optionally, a movable partition can be included to facilitate variable volume of the printing zone(s). Optionally, a movable partition may translate during addition (filling) of the cartridge with photohardenable composition and/or emptying from the cartridge of photohardenable composition and one or more three dimensional objects. Optionally fluid and/or air pressure may be used to facilitate movement of the partition.

A cartridge preferably has a uniform cross-section over its length dimension

A cartridge can have a circular or oval cross-section.

A cartridge can have a polygonal cross-section.

A cartridge preferably has a rectangular or square cross-section.

Optionally a cartridge has an oblong or other elongated shape. Other shapes may also be useful.

A printing zone is preferably configured to facilitate directing one or more, preferably at least two, excitation light projections into a printing zone.

To facilitate directing excitation projections into a printing zone, a printing zone can include one or more optically transparent regions.

Preferably a cartridge includes one or more optically transparent regions positioned for directing the excitation light projection(s) or passage of the excitation light projections into a printing zone in the cartridge. As mentioned above, optionally, the entire cartridge can be optically transparent, all sides of the printing zone can be optically transparent. For an open cartridge, if a cover, which can be removable, is included, it may also be desirable for the cover to be optically transparent

It can be desirable for a cartridge to comprises flat, straight sides that meet at 900 angles.

Preferably a cartridge has a rectangular prism shape. In such case, the rectangular prism shaped cartridge preferably has a uniform cross-section over its longest dimension.

A cartridge (without regard to a port included in a wall or side thereof, if included) can be a one-piece unit or can be constructed from two or more pieces. For example, a cartridge including more than one piece can include side or wall components that are fused together at the edges thereof to form a three-dimensional cartridge unit. Alternatively, the side or wall components can be held together by a frame to form a three-dimensional rectangle. Other construction options may also be suitable.

When a port is included, it is preferably included in a wall other than one through which excitation light will be directed into the volume.

Optionally, one or more of the walls or sides of a cartridge, or the entire cartridge, can be coated. For example, without limitation, one or more sides can include an anti-reflection coating, a mechanically reinforcing coating, a chemical resistance coating, etc. Optionally, one or more sides can include a coating on its internal surface for enhancing the cleanability thereof of the cartridge after it is emptied.

A cartridge may preferably be reusable.

Examples of photoswitchable photoinitiators useful in photopolymerizable compositions can absorb at about 300 nm to about 550, nm, including, but not limited to, about 300 nm to about 450 nm. (The light sheet is preferably generated with light in this wavelength range.) Depending upon the absorption spectrum for the particular photoswitchable photoinitiator, the conversion to the second form can be induced by exposure to any source which emits in this range, e.g., lasers, light emitting diodes, mercury lamps. Filters may be used to limit the output wavelengths. A non-limiting example of filtered light includes filtered emission from a mercury arc lamp, etc. The second form of the photoswitchable photoinitiator will preferably absorb in a range of about 450 to 1000 nm and 450 to 850 nm most typically. (The image projection preferably includes light in this wavelength range.)

Examples of power densities for the first and second wavelengths include power densities in a range from about 0.01 to about 100,000 W/cm².

Examples of exposure energies for the second wavelength light include exposure energies in a range from about 0.001 to about 1,000 mJ/cm². Examples of exposure energies for the first wavelength light include exposure energies in a range from about 0.01 to about 100,000 mJ/cm².

Before printing, a digital file of the object to be printed is obtained. If the digital file is not of a format that can be used to print the object, the digital file is then converted to a format that can be used to print the object. An example of a typical format that can be used for printing is an STL file. Typically, the STL file is then sliced into two-dimensional layers with use of three-dimensional slicer software and converted into G-Code or a set of machine commands, which facilitates building the object. See B. Redwood, et al., “The 3D Printing Handbook-Technologies, designs applications”, 3D HUBS B.V. 2018.

When used as a characteristics of a portion of a cartridge or build chamber, “optically transparent” refers to having high optical transmission to the wavelength of light being used, and “optically flat” refers to being non-distorting (e.g., optical wavefronts entering the portion of the cartridge or build chamber remain largely unaffected).

Those having skill in the art, with the knowledge gained from the present disclosure, will recognize that various changes can be made to the disclosed apparatuses and methods in attaining these and other advantages, without departing from the scope of the present disclosure. As such, it should be understood that the features described herein are susceptible to modification, alteration, changes, or substitution. For example, it is expressly intended that all combinations of those elements and/or steps which perform substantially the same function, in substantially the same way, to achieve the same results are within the scope of the embodiments described herein. Substitutions of elements from one described embodiment to another are also fully intended and contemplated. The specific embodiments illustrated and described herein are for illustrative purposes only, and not limiting of that which is set forth in the appended claims. Other embodiments will be evident to those of skill in the art. It should be understood that the foregoing description is provided for clarity only and is merely exemplary. The spirit and scope of the present disclosure is not limited to the above examples, but is encompassed by the following claims.

1-16. (canceled)

17. A 3D printing assembly comprising:
a printer gripping assembly configured to move a cartridge containing a photohardenable resin;
a printer assembly including at least one excitation light source configured to solidify the photohardenable resin and form one or more 3D objects in the cartridge;
a cartridge flipping assembly configured to insert a basket in an inverted position into the cartridge and rotate the cartridge to an inverted position such that the one or more 3D objects are transferred into the basket and the liquid resin flows out of the cartridge;
a basket gripping assembly configured to remove the basket from the cartridge and transfer the basket to a first washing station;
a second washing station positioned downstream of the first washing station;
a drying station positioned downstream of the second washing station;
a pre-curing station positioned downstream of the drying station;
a transfer assembly configured to transfer the one or more 3D objects from the basket into a curing tray;
an inspection station configured to inspect the one or more 3D objects in the curing tray;
a sealing station configured to secure a sealing film to a top surface of the curing tray; and
a transfer tray configured to receive one or more curing trays.

18. The 3D printing assembly of claim 17, wherein the printer gripping assembly comprises a first set of cartridge grippers configured to grasp the cartridge, and a track along which the first set of grippers may move to transfer the cartridge to a print carriage.

19. The 3D printing assembly of claim 17, wherein the printer gripping assembly comprises a second set of cartridge grippers configured to grasp the cartridge after the cartridge has been removed from the printer assembly.

20. The 3D printing assembly of claim 17, wherein the printer assembly includes a first excitation light source and a second excitation light source, and wherein the first excitation light source is configured to illuminate a projector that patterns an image in a first wavelength of light by forming a time-series of cross-sectional patterns that correspond to cross-sections of the one or more 3D objects to be printed.

21. The 3D printing assembly of claim 20, wherein the second excitation light source is configured to illuminate a light sheet generator for generating and directing a light sheet in a second wavelength that is a different wavelength than the first wavelength.

22. The 3D printing assembly of claim 17, wherein the cartridge flipping assembly includes a pair of basket grippers configured to grasp an empty basket positioned in a basket carriage and position the empty basket into a cartridge in an inverted position, and a pair of cartridge grippers configured to grip the cartridge after the basket has been positioned in the cartridge.

23. The 3D printing assembly of claim 22, wherein the cartridge flipping assembly is configured to rotate the basket and cartridge such that the one or more 3D objects move from the cartridge into the basket and resin that has not hardened into a 3D object flows out of the cartridge into a drip pan.

24. (canceled)

25. The 3D printing assembly of claim 17, wherein the basket gripping assembly includes basket grippers configured to grasp the basket.

26. The 3D printing assembly of claim 25, wherein the basket gripping assembly is configured to move the basket grasped by the basket grippers to the first washing station.

27. (canceled)

28. The 3D printing assembly of claim 26, wherein the basket gripping assembly is configured to move the basket grasped by the basket grippers from the first washing station to the second washing station.

29. (canceled)

30. The 3D printing assembly of claim 28, wherein the basket gripping assembly is configured to move the basket grasped by the basket grippers from the second washing station to the drying station.

31. (canceled)

32. The 3D printing assembly of claim 30, wherein the basket gripping assembly is configured to move the basket grasped by the basket grippers from the drying station to the pre-curing station.

33. (canceled)

34. The 3D printing assembly of claim 17, wherein the transfer assembly includes a transfer arm that includes tray grippers configured to grasp a curing tray seated in a first transfer carriage.

35. The 3D printing assembly of claim 34, wherein the transfer arm includes basket grippers configured to grasp a basket containing the one or more 3D objects.

36. The 3D printing assembly of claim 35, wherein the transfer arm is configured to rotate the basket containing the one or more 3D objects and the curing tray such that the one or more 3D objects slide from the basket into the curing tray.

37. The 3D printing assembly of claim 36, wherein the transfer arm includes separator walls configured to guide the one or more 3D objects from the basket into the curing tray.

38. The 3D printing assembly of claim 17, wherein the inspection station includes a camera.

39. The 3D printing assembly of claim 17, wherein the sealing station includes one or more needles configured to inject an inert gas into the curing tray.

40. The 3D printing assembly of claim 17, wherein the sealing station includes a heat sealing plate configured to seal the sealing film to the curing tray.

41. The 3D printing assembly of claim 17, wherein the cartridge includes two or more printing zones, and wherein the printing zones are spaced apart from one another such that excitation light projections can be directed into one printing zone and at least partially form the three-dimensional object without triggering photopolymerization of the photohardenable composition in an adjacent printing zone.

42-51. (canceled)
